(19) United States
(12) Patent Application Publication
(10) Pub. No.: US 2022/0289228 A1
(43) Pub. Date: Sep. 15, 2022

(54) HMI CONTROL DEVICE, HMI CONTROL METHOD, AND HMI CONTROL PROGRAM PRODUCT

(71) Applicant: DENSO CORPORATION, Kariya-city (JP)

(72) Inventors: Takeshi YAMAMOTO, Kariya-city (JP); Asako NAGATA, Kariya-city (JP); Shizuka YOKOYAMA, Kariya-city (JP); Yuji OTA, Kariya-city (JP); Takuya KUME, Kariya-city (JP); Kazuki KOJIMA, Kariya-city (JP)

(21) Appl. No.: 17/828,936

(22) Filed: May 31, 2022

Related U.S. Application Data
(63) Continuation of application No. PCT/JP2020/043640, filed on Nov. 24, 2020.

(30) Foreign Application Priority Data
Dec. 6, 2019 (JP) 2019-221507
Nov. 20, 2020 (JP) 2020-193416

(51) Int. Cl. B60W 50/14; B60W 30/18

(52) U.S. Cl. CPC B60W 50/14; B60W 30/18163; B60W 2554/406; B60W 2552/10; B60W 2710/20; B60W 2552/05

(57) ABSTRACT

An HMI control device is provided to control an HMI device mounted in a vehicle capable of autonomous steering control. The HMI control device is configured to: acquire an execution status of the autonomous steering control; acquire congestion information; acquire an entry status of the vehicle into a congestion section included in the congestion information; present, on the HMI device, the congestion information and lane information related to a possibility of a lane change in a case where the autonomous steering control is being executed and the entry status indicates an entry into the congestion section; and present, as the lane information, lane change information in a case where (i) a traffic congestion occurs in the congestion section of a different lane and (ii) a congestion traveling after a lane change from an own lane to the different lane in which the traffic congestion is occurred is recommended.

### CROSS REFERENCE TO RELATED APPLICATIONS

The present application is a continuation application of International Patent Application No. PCT/JP2020/043640 filed on Nov. 24, 2020, which designated the U.S. and claims the benefit of priority from Japanese Patent Application No. 2019-221507 filed on Dec. 6, 2019 and Japanese Patent Application No. 2020-193416 filed on Nov. 20, 2020 The entire disclosures of all of the above applications are incorporated herein by reference.

### TECHNICAL FIELD

The present disclosure relates to an HMI control device, an HMI control method, and an HMI control program product for controlling an HMI device mounted in a vehicle capable of autonomous steering control. HMI stands for human-machine interface.

### BACKGROUND

There have been known various techniques for detecting a road condition and performing lane change control on the basis of the detected road condition.

### SUMMARY

The present disclosure provides a human-machine interface (HMI) control device configured to control an HMI device mounted in a vehicle that is capable of performing an autonomous steering control. The HMI control device is configured to: acquire an execution status of the autonomous steering control; acquire a traveling environment of the vehicle including congestion information; acquire an entry status of the vehicle into a congestion section included in the congestion information; present, by the HMI device, the congestion information corresponding to the congestion section and lane information related to a possibility of a lane change of the vehicle in a case where the execution status indicates that the autonomous steering control of the vehicle is being executed and the entry status indicates an entry of the vehicle into the congestion section; and present lane change information as the lane information in a case where (i) a traffic congestion occurs in the congestion section of a different lane which is different from an own lane on which the vehicle is traveling and (ii) a congestion traveling after a lane change from the own lane to the different lane in which the traffic congestion is occurred in the congestion section is recommended.

### BRIEF DESCRIPTION OF DRAWINGS

Objects, features and advantages of the present disclosure will become apparent from the following detailed description made with reference to the accompanying drawings.

FIG. 1 is a block diagram illustrating a schematic configuration of an in-vehicle system including an HMI control device according to an embodiment.

FIG. 2 is a schematic diagram illustrating a display example in a first operation example of the HMI device illustrated in FIG. 1.

FIG. 3 is a schematic diagram illustrating a display example in the first operation example of the HMI device illustrated in FIG. 1.

FIG. 4 is a schematic diagram illustrating a display example in the first operation example of the HMI device illustrated in FIG. 1.

FIG. 5 is a schematic diagram illustrating a display example in the first operation example of the HMI device illustrated in FIG. 1.

FIG. 6 is a flowchart schematically illustrating the first operation example of the HMI device illustrated in FIG. 1.

FIG. 7 is a schematic diagram illustrating a display example in a second operation example of the HMI device illustrated in FIG. 1.

FIG. 8 is a schematic diagram illustrating a display example in the second operation example of the HMI device illustrated in FIG. 1.

FIG. 9 is a schematic diagram illustrating a display example in the second operation example of the HMI device illustrated in FIG. 1.

FIG. 10 is a schematic diagram illustrating a display example in the second operation example of the HMI device illustrated in FIG. 1.

FIG. 11 is a schematic diagram illustrating a display example in a third operation example of the HMI device illustrated in FIG. 1.

FIG. 12 is a schematic diagram illustrating a display example in the third operation example of the HMI device illustrated in FIG. 1.

FIG. 13 is a schematic diagram illustrating a display example in the third operation example of the HMI device illustrated in FIG. 1.

FIG. 14 is a schematic diagram illustrating a display example in the third operation example of the HMI device illustrated in FIG. 1.

FIG. 15 is a schematic diagram illustrating a display example in the third operation example of the HMI device illustrated in FIG. 1.

FIG. 16 is a schematic diagram illustrating a display example in the third operation example of the HMI device illustrated in FIG. 1.

FIG. 17 is a schematic diagram illustrating a display example in the third operation example of the HMI device illustrated in FIG. 1.

FIG. 18 is a schematic diagram illustrating a display example in the third operation example of the HMI device illustrated in FIG. 1.

FIG. 19 is a schematic diagram illustrating a display example in the third operation example of the HMI device illustrated in FIG. 1.

FIG. 20 is a schematic diagram illustrating a display example in the third operation example of the HMI device illustrated in FIG. 1.

FIG. 21 is a schematic diagram illustrating a display example in the third operation example of the HMI device illustrated in FIG. 1.

FIG. 22 is a schematic diagram illustrating a display example in the third operation example of the HMI device illustrated in FIG. 1.

FIG. 23 is a schematic view illustrating a display example in a fourth operation example of the HMI device illustrated in FIG. 1.

FIG. 24 is a schematic diagram illustrating a display example in a first additional operation example of the HMI device illustrated in FIG. 1.

FIG. 25 is a schematic diagram illustrating a display example in a second additional operation example of the HMI device illustrated in FIG. 1.

FIG. 26 is a schematic diagram illustrating a display example in a second additional operation example of the HMI device illustrated in FIG. 1.

FIG. 27 is a schematic diagram illustrating a display example in a second additional operation example of the HMI device illustrated in FIG. 1.

FIG. 28 is a schematic diagram illustrating a display example in a third additional operation example of the HMI device illustrated in FIG. 1.

FIG. 29 is a schematic diagram illustrating a display example in the third additional operation example of the HMI device illustrated in FIG. 1.

FIG. 30 is a schematic diagram illustrating a display example in the third additional operation example of the HMI device illustrated in FIG. 1.

FIG. 31 is a schematic view illustrating a display example in a fourth additional operation example of the HMI device illustrated in FIG. 1.

FIG. 32 is a schematic view illustrating a display example in the fourth additional operation example of the HMI device illustrated in FIG. 1.

FIG. 33 is a schematic view illustrating a display example in the fourth additional operation example of the HMI device illustrated in FIG. 1.

### DETAILED DESCRIPTION

Conventionally, various techniques for detecting a road condition and performing lane change control on the basis of the detected road condition have been proposed. For example, an autonomous driving device controls an own vehicle so as to change to another lane when detecting that the lane in which the own vehicle is traveling is congested.

In such a technique for automatically selecting or changing the lane on which the own vehicle travels, a status may occur in which an occupant of the own vehicle such as a driver feels uncomfortable or suspicious about the result of the selection or change of the lane.

According to an aspect of the present disclosure, an HMI control device is configured to control an HMI device mounted in a vehicle that is capable of performing an autonomous steering control. The HMI control device includes: a control status acquisition unit that acquires an execution status of the autonomous steering control; a traveling environment acquisition unit that acquires a traveling environment of the vehicle including congestion information; an entry status acquisition unit that acquires an entry status of the vehicle into a congestion section included in the congestion information; and a presentation control unit that presents, by the HMI device, the congestion information corresponding to the congestion section and lane information related to a possibility of a lane change of the vehicle in a case where the execution status indicates that the autonomous steering control of the vehicle is being executed and the entry status indicates an entry of the vehicle into the congestion section. The presentation control unit presents lane change information as the lane information in a case where (i) a traffic congestion occurs in the congestion section of a different lane which is different from an own lane on which the vehicle is traveling and (ii) a congestion traveling after a lane change from the own lane to the different lane in which the traffic congestion is occurred in the congestion section is recommended.

According to another aspect of the present disclosure, an HMI control device is configured to control an HMI device mounted in a vehicle capable of autonomous steering control. The HMI control device includes: a control status acquisition unit that acquires an execution status of the autonomous steering control; a traveling environment acquisition unit that acquires a traveling environment of the vehicle including traffic information; and a presentation control unit that presents, by the HMI device, the traffic information and lane information, in a case where the execution status indicates that the autonomous steering control of the vehicle is being executed, the lane information indicating at least one of a driving autonomy level executable in a change destination lane to which the lane change is made or a driving condition of the change destination lane to which the lane change is made.

According to another aspect of the present disclosure, an HMI control method of controlling an HMI device mounted in a vehicle capable of autonomous steering control is provided. The HMI control method may be implemented by instructions to be executed by at least one processor, and the instructions may be stored in a computer-readable non-transitory storage medium. The instructions include: acquiring an execution status of the autonomous steering control; acquiring a traveling environment of the vehicle including congestion information; acquiring an entry status of the vehicle into a congestion section included in the congestion information; presenting, by the HMI device, the congestion information corresponding to the congestion section and lane information related to a possibility of a lane change of the vehicle in a case where the execution status indicates that the autonomous steering control of the vehicle is being executed and the entry status indicates an entry of the vehicle into the congestion section; and presenting, as the lane information, lane change information in a case where (i) a traffic congestion occurs in the congestion section of a different lane which is different from an own lane on which the vehicle is traveling and (ii) a congestion traveling after a lane change from the own lane to the different lane in which the traffic congestion is occurred in the congestion section is recommended.

According to another aspect of the present disclosure, an HMI control program product stored in a computer-readable non-transitory storage medium is provided. The HMI control program product includes instructions to be executed by at least one processor of an HMI control device to control an HMI device, which mounted in a vehicle capable of autonomous steering control. The instructions include: acquiring an execution status of the autonomous steering control; acquiring a traveling environment of the vehicle including congestion information; acquiring an entry status of the vehicle into a congestion section included in the congestion information; presenting, by the HMI device, the congestion information corresponding to the congestion section and lane information related to a possibility of a lane change of the vehicle in a case where the execution status indicates that the autonomous steering control of the vehicle is being executed and the entry status indicates an entry of the vehicle into the congestion section; and presenting, as the lane information, lane change information in a case where (i) a traffic congestion occurs in the congestion section of a different lane which is different from an own lane on which the vehicle is traveling and (ii) a congestion traveling after a lane change from the own lane to the different lane in which the traffic congestion is occurred in the congestion section is recommended.

According to the above-described aspects of the present disclosure, it is possible to improve the confidence of an occupant of an own vehicle in a result of automatic lane selection or automatic lane change by the own vehicle.

### EMBODIMENTS

In the following, an embodiment of the present disclosure will be described with reference to the drawings. When descriptions of various modifications applicable to one embodiment are inserted in the middle of a series of descriptions concerning the embodiment, the understanding of the embodiment may be hindered. Therefore, the modifications will not be described in the middle of a series of descriptions concerning the embodiment but collectively described thereafter.

(Configuration)

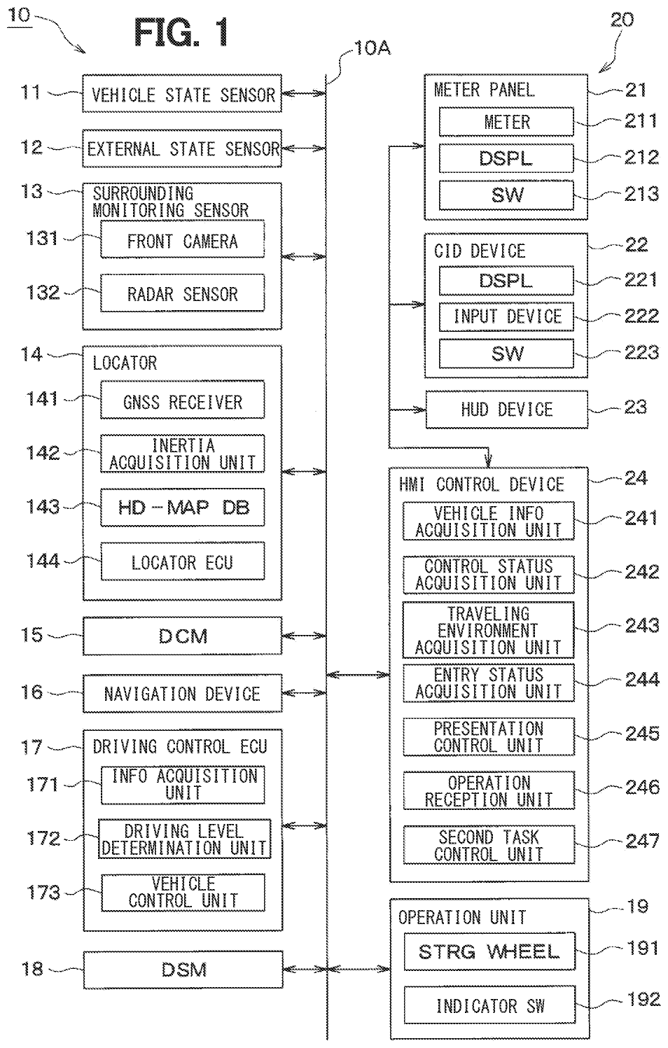

Referring to FIG. 1, an in-vehicle system 10 is configured to exhibit a function as a driving automation system in an automobile as a vehicle by being mounted in the vehicle. Hereinafter, the vehicle mounted with the in-vehicle system 10 may be referred to as an “own vehicle”. Specifically, in the present embodiment, the in-vehicle system 10 is configured to be able to achieve at least autonomous steering driving.

The “autonomous steering driving” means that the driving automation system is in charge of or executes at least steering, that is, a lateral vehicle motion control subtask among the dynamic driving tasks, defined in the standard “SAE J3016” published by SAE International. SAE stands for Society of Automotive Engineers. The “dynamic driving task” is all operational and tactical functions that need to be performed in real time at the time of operating a vehicle in road traffic, excluding strategic functions. The “strategic function” is a traveling plan, waypoint selection, and the like.

That is, the “autonomous steering driving” is typically a driving autonomy level corresponding to level 1 or level 2 in “SAE J3016”. However, the “autonomous steering driving” is a concept including so-called “autonomous driving” corresponding to any one of levels 3 to 5 in “SAE J3016”. The “autonomous driving” refers to a driving autonomy level corresponding to Levels 3 to 5 in “SAE J3016” at which the driving automation system is in charge of, that is, executes, all dynamic driving tasks. A level X in “SAE J3016” is hereinafter referred to as “SAE Level X”. X is any of 0 to 5. For the purpose of simplifying the description, the present embodiment is premised on a road traffic system in which both “high-speed autonomous driving” and “congestion autonomous driving” to be defined below are possible, and a lane change during each of these autonomous driving is also possible. That is, in the present embodiment, the in-vehicle system 10 is configured such that the own vehicle can execute a “hands-off driving” corresponding to SAE Level 2 and the “high-speed autonomous driving” and/or the “congestion autonomous driving” corresponding to SAE Level 3.

The “hands-off driving” means that the driving automation system automatically performs start, steering, acceleration/deceleration, and stop control on a condition that the driver appropriately responds to an intervention request or the like from the driving automation system. The “driver” is an occupant in charge of or executing a dynamic driving task, typically, an occupant seated on a driver's seat in the own vehicle, and may also be referred to as an “occupant on the driver's seat”. The “high-speed autonomous driving” is autonomous driving in which traveling in a predetermined high-speed range is possible in a specific section as a limited area defined in “SAE J3016”. The “high-speed autonomous driving” may also be referred to as “high-speed range autonomous driving”. The “specific section” is a traveling section, set in advance so that the autonomous driving at SAE Level 3 is possible, and is typically, for example, a predetermined section set on an expressway such as a highway. The predetermined high-speed range is, for example, 60 km/h or more and a legal speed or less. The “congestion autonomous driving” is autonomous driving in which traveling in a predetermined low-speed range is possible in a congestion section as the limited area described above. The “congestion section” is a section from the head to the end of a congestion line. The predetermined low-speed range is, for example, less than 60 km/h.

(Overall System Configuration)

The in-vehicle system 10 is an in-vehicle network including an in-vehicle communication line 10A and a plurality of nodes and the like connected to each other via the in-vehicle communication line 10A and is configured to be able to perform various vehicle controls during the driving of the own vehicle, various display operations associated with the various vehicle controls, and the like. The in-vehicle system 10 is configured to conform to a predetermined communication standard such as CAN (international registered trademark: international registered number 1048262A). CAN (international registered trademark) stands for Controller Area Network.

The in-vehicle system 10 includes a vehicle state sensor 11, an external state sensor 12, a surrounding monitoring sensor 13, a locator 14, a DCM 15, a navigation device 16, a driving control ECU 17, a DSM 18, an operation unit 19, and an HMI device 20. DCM stands for data communication module. ECU stands for electronic control unit. DSM stands for driver status monitor. The vehicle state sensor 11 to the HMI device 20 are connected to each other via the in-vehicle communication line 10A.

The HMI device 20 includes a meter panel 21, a CID device 22, an HUD device 23, and an HMI control device 24. CID stands for center information display. HUD stands for head-up display. The meter panel 21, the CID device 22, and the HUD device 23 are connected to the HMI control device 24 via a sub-communication line different from the in-vehicle communication line 10A so as to be able to perform information communication. The HMI control device 24 is provided as a node connected to the in-vehicle communication line 10A.

(Various Sensors)

The vehicle state sensor 11 is provided to generate outputs corresponding to various amounts related to the driving state of the own vehicle. The “various amounts related to the driving state” include various amounts related to the state of the driving operation by the driver or the driving automation system, such as an accelerator operation amount, a brake operation amount, a shift position, and a steering angle. The “various amounts related to the driving state” include physical amounts related to the behavior of the own vehicle, such as vehicle speed, angular velocity, longitudinal acceleration, and lateral acceleration. That is, the vehicle state sensor 11 is a generic name of well-known sensors necessary for vehicle driving control, such as an accelerator opening sensor, a steering angle sensor, a wheel speed sensor, an angular velocity sensor, and an acceleration sensor, for simplification of illustration and description. The vehicle state sensor ibis provided to be able to provide a detection output to each unit such as the driving control ECU 17 via the in-vehicle communication line 10A.

The external state sensor 12 is provided to generate outputs corresponding to various amounts mainly related to the natural environment among traffic environments around the own vehicle. The “various amounts related to the natural environment” include, for example, physical amounts such as an outside temperature, a rainfall amount, and illuminance. That is, the external state sensor 12 is a generic term for well-known sensors, such as an outside air temperature sensor, a raindrop sensor, and an illuminance sensor, for simplification of illustration and description. The external state sensor 12 is provided to be able to provide a detection output to each unit such as the driving control ECU 17 via the in-vehicle communication line 10A.

The surrounding monitoring sensor 13 is provided to mainly detect a traffic environment except for that detectable by the external state sensor 12 among the surrounding traffic environments of the own vehicle. Specifically, the surrounding monitoring sensor 13 is configured to be able to detect a moving object and a stationary object in a predetermined detection range around the own vehicle. The “moving object” includes a pedestrian, a cyclist, an animal, and another vehicle that is traveling. The “stationary object” includes a roadside structure (e.g., wall, building, etc.) in addition to an on-road dropped object, a guardrail, a curb, a parked or stopped vehicle, a road sign, and a road marking. The surrounding monitoring sensor 13 may also be referred to as an “ADAS sensor”. ADAS stands for advanced driver-assistance systems.

In the present embodiment, the surrounding monitoring sensor 13 includes a front camera 131 and a radar sensor 132 as a configuration for detecting a moving object and a stationary object. The front camera 131 is provided to capture the images on the front side and the front lateral side of the own vehicle. The front camera 131 is a digital camera device and includes an image sensor such as a CCD or a CMOS. CCD stands for charge-coupled device. CMOS stands for complementary metal-oxide-semiconductor.

The radar sensor 132 is a millimeter-wave radar sensor, a submillimeter-wave radar sensor, or a laser radar sensor configured to transmit and receive radar waves and is mounted in a front surface portion of a vehicle body of the own vehicle. The radar sensor 132 is configured to output a signal corresponding to a position and a relative speed of a reflection point. The “reflection point” is a point at which a radar wave is estimated to have been reflected on the surface of an object present around the own vehicle. The “relative speed” is a relative speed of a reflection point, that is, an object having reflected a radar wave, with respect to the own vehicle.

(Locator)

The locator 14 is configured to determine highly accurate position information or the like of the own vehicle by so-called complex positioning. Specifically, the locator 14 includes a GNSS receiver 141, an inertial acquisition unit 142, a high-precision map DB (HD-MAP DB)143, and a locator ECU 144. GNSS stands for global navigation satellite system. DB stands for database. The “highly accurate position information” is, for example, position information of SAE Level 2 or higher and having position accuracy to such an extent that the position information can be used for advanced driving assistance or autonomous driving, specifically, an error is less than 10 cm.

The GNSS receiver 141 is provided to receive positioning signals transmitted from a plurality of positioning satellites, that is, artificial satellites. In the present embodiment, the GNSS receiver 141 is configured to be able to receive a positioning signal from a positioning satellite in at least one of satellite positioning systems such as GPS, QZSS, GLONASS, Galileo, IRNSS, and the BeiDou Navigation Satellite System. GPS stands for Global Positioning System. QZSS stands for Quasi-Zenith Satellite System. GLONASS stands for Global Navigation Satellite System. IRNSS stands for Indian Regional Navigation Satellite System.

The inertial acquisition unit 142 is configured to acquire acceleration and angular velocity acting on the own vehicle. In the present embodiment, the inertial acquisition unit 142 is provided as a three-axis gyro sensor and a three-axis acceleration sensor built in a box-shaped housing of the locator 14.

The high-precision map DB 143 is mainly configured by a nonvolatile rewritable memory so as to store high-precision map information in a rewritable manner and to hold the stored contents even during power interruption. The nonvolatile rewritable memory is, for example, a hard disk, an EEPROM, a flash ROM, or the like. EEPROM stands for electronically erasable and programmable ROM. ROM stands for read-only memory. The high-precision map information may also be referred to as high-precision map data. The high-precision map information includes map information with higher precision than map information used in a conventional car navigation system corresponding to a position error of about several meters. Specifically, the high-precision map DB 143 stores information that can be used for advanced driving assistance or autonomous driving, such as three-dimensional road shape information, lane number information, and regulation information, conforming to a predetermined standard such as the ADASIS standard. ADASIS stands for Advanced Driver Assistance Systems Interface Specification.

The locator ECU 144 is configured as a so-called in-vehicle microcomputer including a CPU, a ROM, a RAM, an input/output interface, and the like (not illustrated). CPU stands for central processing unit. RAM stands for random-access memory. The locator ECU 144 is configured to sequentially determine the position, the direction, and the like of the own vehicle on the basis of the positioning signal received by the GNSS receiver 141, the acceleration and the angular velocity acquired by the inertial acquisition unit 142, the vehicle speed acquired from the vehicle state sensor 11, and the like. The locator 14 is provided to be able to provide the determination result of the position, the direction, and the like by the locator ECU 144 to each unit such as the navigation device 16, the driving control ECU 17, and the HMI control device 24 via the in-vehicle communication line 10A.

(DCM)

The DCM 15 is an in-vehicle communication module and is provided to be able to perform information communication with a base station around the own vehicle by wireless communication conforming to a communication standard such as LTE or 5G. LTE stands for Long Term Evolution. 5G stands for fifth generation.

Specifically, for example, the DCM 15 is configured to obtain the latest high-precision map information from a probe server on a cloud. Further, the DCM 15 stores the acquired latest high-precision map information into the high-precision map DB 143 in cooperation with the locator ECU 144. Moreover, the DCM 15 is configured to acquire traffic information such as congestion information from the probe server and/or a predetermined database described above. The “congestion information” includes the position and length of the congestion section. Specifically, the congestion information includes a congestion head position, a congestion end position, an estimated congestion distance, an estimated congestion time, and the like. The traffic information is also referred to as “road traffic information”.

(Navigation Device)

The navigation device 16 is provided to calculate a scheduled traveling route from the current position of the own vehicle to a predetermined destination. In the present embodiment, the navigation device 16 is configured to calculate the scheduled traveling route on the basis of a destination set by the driver or the like of the own vehicle, high-precision map information acquired from the locator 14, and position information and direction information of the own vehicle acquired from the locator 14. The navigation device 16 is provided to be able to provide various information including route information as a calculation result to each unit such as the driving control ECU 17 and the HMI control device 24 via the in-vehicle communication line 10A. That is, the navigation device 16 performs navigation screen display for map display, route display, and the like on the HMI device 20.

(Driving Control ECU)

The driving control ECU 17 is provided to control the driving of the own vehicle on the basis of signals and information acquired from the vehicle state sensor 11, the external state sensor 12, the surrounding monitoring sensor 13, the locator 14, and the like. That is, the driving control ECU 17 is configured to perform a predetermined driving control operation. In the present embodiment, the “predetermined driving control operation” includes a vehicle control operation, that is, a dynamic driving task execution operation, corresponding to SAE Levels 1 to 3. In the present embodiment, the driving control ECU 17 is configured to be able to set the driving autonomy level in the own vehicle to any one of SAE Levels 0 to 3.

The driving control ECU 17 has a configuration as a so-called in-vehicle microcomputer including a CPU, a ROM, a nonvolatile rewritable memory, a RAM, an input/output interface, and the like (not illustrated). Specifically, the driving control ECU 17 includes an information acquisition unit 171, a driving level determination unit 172, and a vehicle control unit 173 as functional configurations or functional units achieved on the in-vehicle microcomputer.

The information acquisition unit 171 is provided to acquire at least the traveling state of the own vehicle. The “traveling state” includes a driving state, a traffic environment, and the like detected or acquired by the vehicle state sensor 11, the external state sensor 12, the surrounding monitoring sensor 13, and the like. The information acquisition unit 171 is provided to acquire the current position of the own vehicle and traffic information concerning a road on which the own vehicle is currently traveling. That is, the information acquisition unit 171 acquires information necessary for vehicle control corresponding to SAE Levels 1 to 3 from the vehicle state sensor 11, the external state sensor 12, the surrounding monitoring sensor 13, the locator 14, the DCM 15, and the like.

The driving level determination unit 172 is provided to set the driving autonomy level of the own vehicle to any one of SAE Levels 0 to 3 on the basis of the traveling state and the like acquired by the information acquisition unit 171. Specifically, the driving level determination unit 172 determines whether or not a start condition for a predetermined driving autonomy level has been satisfied, and starts the driving autonomy level when receiving an approval operation by the driver while the condition is satisfied. When the continuation condition is not satisfied during the execution of the driving autonomy level, the driving level determination unit 172 perform control necessary for terminating the driving autonomy level. The driving control ECU 17 is provided to be able to provide the setting result of the driving autonomy level by the driving level determination unit 172 to each unit such as the HMI control device 24 via the in-vehicle communication line 10A.

The vehicle control unit 173 is provided to perform a vehicle motion control subtask corresponding to the driving autonomy level determined by the driving level determination unit 172. That is, when the driving autonomy level is set to any one of SAE Levels 1 to 3, the vehicle control unit 173 performs vehicle speed control, steering control, braking control, and the like in accordance with the set driving autonomy level.

(DSM)

The DSM 18 is provided to detect the state of the driver by image recognition based on an image captured by an in-vehicle camera including an image sensor such as a CCD or a CMOS. Further, the DSM 18 is configured to issue a warning or the like concerning inattentive driving or the like by using a speaker (not illustrated) or the like provided on a dashboard or the like on the basis of the detection result of the state of the driver. Moreover, the DSM 18 is provided to be able to provide the detection result of the state of the driver to each unit such as the driving control ECU 17 and the HMI control device 24 via the in-vehicle communication line 10A.

(Operation Unit)

The operation unit 19 is provided to receive a manual input operation by the driver. Specifically, the operation unit 19 includes a steering wheel (STRG WHEEL) 191, an indicator switch (indicator SW) 192, and the like. The steering wheel 191 is fixed to a steering shaft (not illustrated) rotatably supported by a steering column (not illustrated). The indicator switch 192 is configured to output a signal corresponding to an operation state of an indicator lever (not illustrated) that is an operation lever provided in the steering column. The operation unit 19 includes a steering switch (not illustrated) and the like. The steering switch is provided on a spoke portion (not illustrated) or the like of the steering wheel 191. The operation unit 19 is provided to be able to provide a result of receiving an input operation by the driver to each unit such as the driving control ECU 17 and the HMI control device 24 via the in-vehicle communication line 10A.

(HMI Device)

The HMI device 20 is provided to at least visually present various information concerning the own vehicle to the driver and to receive an input operation of the driver corresponding to the presentation contents. In the present embodiment, the HMI device 20 mounted in the own vehicle capable of autonomous steering control is configured to be able to present various information concerning autonomous steering driving and receiving an input operation by the driver. The “information presentation” is, for example, various types of guidance, an input operation instruction, an input operation content notification, a warning, and the like.

As described above, the HMI device 20 includes the meter panel 21, the CID device 22, and the HUD device 23 provided on the dashboard (not illustrated). That is, in the present embodiment, the HMI device 20 has a configuration as a so-called “dashboard HMI” attached to a dashboard (not illustrated). The HMI device 20 includes a speaker (not illustrated) for performing information presentation by voice.

The meter panel 21 includes a meter 211, a meter display (DSPL) 212, and a meter switch (SW) 213. The meter 211 is provided to perform meter display of the vehicle speed of the own vehicle, the cooling water temperature, the remaining fuel amount, and the like. The meter display 212 is an information display unit or an information display area provided at the center of the meter panel 21 in the vehicle width direction and is provided to display various information such as date and time, outside temperature, traveling distance, and radio receiving stations. In the present embodiment, the meter display 212 has a configuration as a display device that is a liquid crystal display or an organic EL display including a substantially rectangular displayable area. EL stands for electroluminescence. The meter switch 213 is provided to be able to receive various operations concerning a display state or display contents in the meter 211 and/or the meter display 212, for example, a reset operation of a trip meter.

The CID device 22 is provided on a dashboard. The CID device 22 is provided to be able to display a navigation display screen for map display, route display, and the like by the navigation device 16. The CID device 22 is provided to be able to also display information and contents different from those of the navigation display screen. Specifically, the CID device 22 is configured to be able to perform display related to a traveling mode, such as “comfort”, “normal”, “sports”, and “circuit”.

The CID device 22 is configured to be able to perform display related to a second task available to the driver during the autonomous driving at SAE Level 3. The second task is a task executed by the driver except for a driving operation. Specifically, the second task includes, for example, a mobile communication terminal operation, video content viewing, and the like. The second task is also referred to as a “non-driving task” or a “secondary activity”.

The CID device 22 includes a CID display (DSPL) 221, an input device 222, and a CID switch (SW) 223. The CID display 221 is provided substantially at the center of the dashboard in the vehicle width direction, that is, at a position between the driver's seat and a passenger seat, so as to be visually recognizable from at least the driver. The CID display 221 has a configuration as a display device that is a liquid crystal display or an organic EL display. When the second task is viewing video content, the CID display 221 is configured to display a video of the video content as an image by the display device. The “video content” is, for example, a movie, a concert video, a music video, a television broadcast, or the like.

The input device 222 is a transparent touch panel and is provided to cover the CID display 221 by being superimposed on the CID display 221. That is, the input device 222 is configured to be able to receive an input operation by the driver or the like corresponding to the display while causing the driver or the like to visually recognize the display on the CID display 221. The CID switch 223 includes a plurality of manual operation switches disposed around the CID display 221 and the input device 222.

The HUD device 23 is provided to display a display image including characters and/or symbols in front of the driver. That is, the HUD device 23 is configured to form a virtual image display image ahead of the driver's seat by using the augmented reality (AR) technology, thereby superimposing and displaying the display image on the foreground including the road surface in a place to which the own vehicle is going. The “superimposed display” in the HUD device 23 means that related information (e.g., building name) of a superimposition target (e.g., building) included in the foreground is displayed so as to overlap the superimposition target or in the vicinity of the superimposition target, whereby the superimposition target and the related information are displayed while being associated with each other. The route display to the front road surface, the proceeding-direction display, the traffic information display, and the like also correspond to the “superimposed display”. Specifically, the HUD device 23 projects display image light constituting a display image onto a predetermined projection range of a front windshield (not illustrated) and causes the driver to visually recognize reflected light of the display image light by the front windshield, thereby performing AR display of the display image.

(HMI Control Device)

Referring again to FIG. 1, the HMI control device 24 is provided to control the operation of the HMI device 20. That is, the HMI control device 24 is configured as an HCU that controls operations of the meter panel 21, the CID device 22, the HUD device 23, and the like included in the HMI device 20. HCU stands for HMI control unit.

The HMI control device 24 has a configuration as a so-called in-vehicle microcomputer including a CPU, a ROM, a nonvolatile rewritable memory, a RAM, an input/output interface, and the like (not illustrated). The HMI control device 24 has the following functional configurations or functional units achieved on a microcomputer. That is, the HMI control device 24 includes a vehicle information acquisition unit 241, a control status acquisition unit 242, a traveling environment acquisition unit 243, an entry status acquisition unit 244, a presentation control unit 245, an operation reception unit 246, and a second task control unit 247.

The vehicle information acquisition unit 241 is provided to acquire information related to the driving state of the own vehicle. Specifically, the vehicle information acquisition unit 241 acquires various amounts related to the driving state of the own vehicle detected or acquired by the vehicle state sensor 11. The vehicle information acquisition unit 241 acquires the detection result of the behavior of the driver by the DSM 18.

The control status acquisition unit 242 is provided to acquire an execution status of autonomous steering control in the own vehicle. Specifically, the control status acquisition unit 242 acquires a result of determination or setting of the driving autonomy level by the driving level determination unit 172 from the driving control ECU 17.

The traveling environment acquisition unit 243 is provided to acquire the traveling environment of the own vehicle including congestion information. Specifically, the traveling environment acquisition unit 243 acquires a traffic environment around the own vehicle detected or acquired by the external state sensor 12 and the surrounding monitoring sensor 13. The traveling environment acquisition unit 243 acquires the current position of the own vehicle, a scheduled traveling route, a traffic information in the scheduled traveling route from the locator 14 and the navigation device 16.

The entry status acquisition unit 244 is provided to acquire the status of entry of the own vehicle into the congestion section included in the congestion information. Specifically, the entry status acquisition unit 244 determines whether or not the own vehicle has entered the congestion section on the basis of the traffic environment around the own vehicle, the congestion information, and the current position acquired by the traveling environment acquisition unit 243. The term “entry” as used herein includes both a case where the own vehicle queues up at the end of a congestion line and starts the congestion traveling and a case where the own vehicle is currently congestion traveling in a congestion line.

The presentation control unit 245 is provided to control an information presentation operation by the HMI device 20. That is, the presentation control unit 245 presents various information to the occupant of the own vehicle including the driver by controlling the image output and the sound output in the meter panel 21, the CID device 22, and the HUD device 23. The “various information” includes route information, congestion information, various messages, and the like.

The operation reception unit 246 is provided to receive an input operation in the HMI device 20 by the occupant of the own vehicle including the driver. Specifically, the operation reception unit 246 acquires or monitors a reception state or a reception result of an input operation by the meter switch 213, the input device 222, or the CID switch 223 corresponding to various information presented by the presentation control unit 245.

The second task control unit 247 is provided to control the use or execution of the second task by the HMI device 20. Specifically, the second task control unit 247 controls the output state of the second task content in the CID device 22 on the basis of the driving autonomy level acquired by the control status acquisition unit 242 and the input operation reception result acquired by the operation reception unit 246. The second task control unit 247 is also referred to as a task control unit.

(Outline of Operation: First Embodiment)

Hereinafter, the operation of the HMI control device 24 according to the present embodiment and the outline of the HMI control method and the HMI control program executed by the HMI control device 24 will be described together with the effects exerted by the present embodiment.

The information acquisition unit 171 in the driving control ECU 17 acquires various information including the traveling state of the own vehicle. Specifically, the information acquisition unit 171 acquires the driving state and the traffic environment of the own vehicle from the vehicle state sensor 11, the external state sensor 12, and the surrounding monitoring sensor 13. The information acquisition unit 171 acquires the current position of the own vehicle, a scheduled traveling route, and traffic information concerning the scheduled traveling route from the locator 14 and the navigation device 16. The information acquisition unit 171 acquires the state of the driver from the DSM 18. The information acquisition unit 171 acquires the states of the operations in the operation unit 19 and the HMI device 20 by the driver or the like.

The driving level determination unit 172 determines the start condition for the driving autonomy level corresponding to SAE Levels 1 to 3 on the basis of various information such as the traveling state acquired by the information acquisition unit 171. When the start condition for the predetermined driving autonomy level is satisfied, the driving level determination unit 172 determines the execution of the driving autonomy level. Then, the vehicle control unit 173 performs vehicle speed control, steering control, braking control, and the like in accordance with the driving autonomy level determined by the driving level determination unit 172.

In principle, the driver is not required to perform the steering control operation and the acceleration/deceleration control operation during autonomous driving at SAE Level 3. Therefore, during autonomous driving, the driver is not required to constantly hold the steering wheel 191 and is not required to constantly maintain a driving posture to such an extent that the driver can operate the accelerator pedal and brake pedal at any time. Therefore, during autonomous driving, the driver can execute or use the second task.

On the other hand, during the hands-off driving at SAE Level 2, it is necessary to continuously monitor the traffic condition related to the traveling of the own vehicle to such an extent that the driver can execute manual driving corresponding to SAE Level 0 at any time. The “traffic condition” includes a road condition corresponding to traffic information such as congestion information in addition to the traffic environment around the own vehicle. Therefore, during hands-off driving, the driver is not required to constantly hold the steering wheel 191 but needs to maintain a posture to such an extent that immediate driving switch is possible.

For example, during autonomous steering driving, there may be a case where the driving control ECU does not attempt to change lanes for avoiding traffic congestion even when the own vehicle approaches the end of the traffic congestion, or on the contrary, the driving control ECU 17 intentionally attempts to change lanes so that the own vehicle will queue up at the end of the traffic congestion. Specifically, for example, it is assumed that, during traveling on a left-side traffic road having three lanes on each side, a long traffic congestion has occurred only in a right-turn possible lane closest to the center of the road to such an extent that visibility to a scheduled right-turn intersection is poor. In such a status, there may be a case where the own vehicle does not attempt to change lanes from a right-turn possible lane in which traffic congestion has occurred to another traveling lane, or attempts to change lanes from another traveling lane to a right-turn possible lane in which traffic congestion has occurred. Alternatively, for example, a case is assumed where traffic congestion from a branch guidance lane toward an interchange or the like to the leftmost traveling lane on the main lane road, that is, a first traveling lane, has occurred on an expressway, which is a left side traffic road having three lanes on each side. The “branch guidance lane” is a lane provided to run parallel with the main lane road between the traveling lane in the main lane road and the shoulder in order to connect a branch road branching off the main lane road at an interchange or the like, that is, a slip road, and the main lane road. The “interchange or the like” includes a junction, a parking area, and a service area. In such an assumed case, there may be a case where the own vehicle attempts to change lanes to the first traveling lane in which traffic congestion has occurred during high-speed autonomous driving in a second traveling lane.

In the above case, it may be difficult for the occupant of the own vehicle including the driver to determine whether or not the result of automatic lane selection or change by the driving control ECU 17 is appropriate. Specifically, for example, in the above scene, the occupant of the own vehicle may wonder why the own vehicle intentionally tries to queue up at the end of the traffic congestion. In particular, the driver may not pay sufficient attention to the most recent driving status of the own vehicle and/or the traffic status around the own vehicle during the use of the second task. Furthermore, whether or not to change lanes may be adapted to artificial selection corresponding to the preference or circumstances of the occupant including the driver rather than automatic selection on the in-vehicle system 10 side.

As described above, the occupant of the own vehicle such as the driver may feel discomfort or doubt about the result of automatic lane selection or change during autonomous steering driving (e.g., autonomous driving or hands-off driving). Therefore, the control status acquisition unit 242 acquires the execution status of the autonomous steering control. Further, the traveling environment acquisition unit 243 acquires the traveling environment of the own vehicle including congestion information. Moreover, the entry status acquisition unit 244 acquires the status of entry of the own vehicle into the congestion section included in the acquired congestion information. The presentation control unit 245 controls the information presentation operation by the HMI device 20 in accordance with the acquisition results of the control status acquisition unit 242, the traveling environment acquisition unit 243, and the entry status acquisition unit 244.

Specifically, in a predetermined case, the presentation control unit 245 presents, by the HMI device 20, congestion information corresponding to the congestion section and lane information related to the possibility of a lane change in the own vehicle. The “predetermined case” is a case where the execution status of the autonomous steering control acquired by the control status acquisition unit 242 is that the autonomous steering control is being executed in the own vehicle, and the entry status acquired by the entry status acquisition unit 244 is that the own vehicle enters the congestion section.

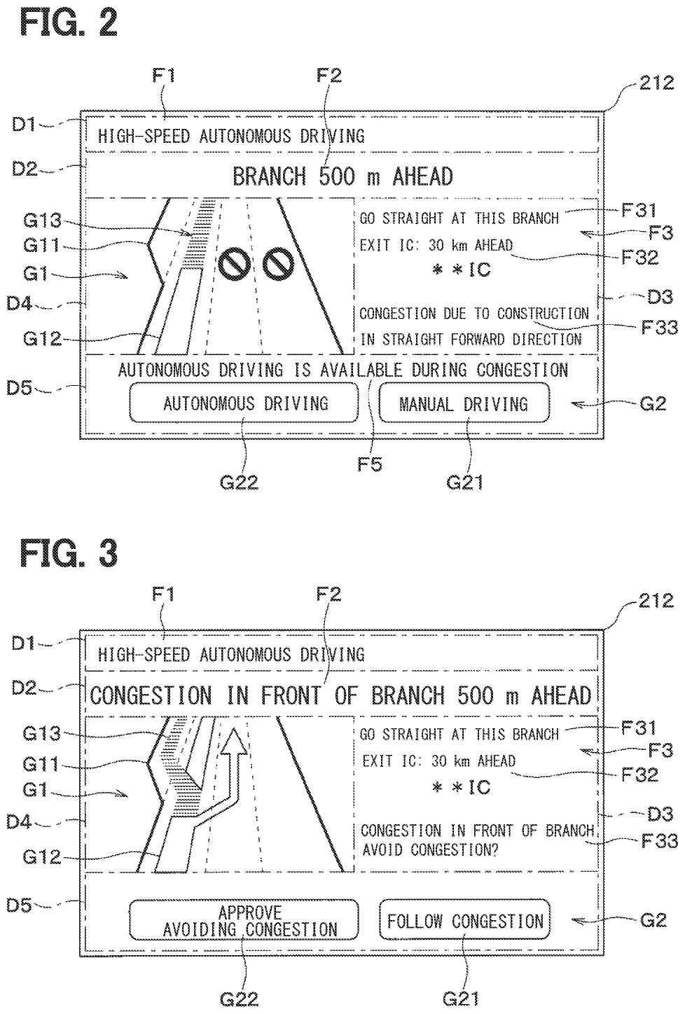

As a specific example, FIGS. 2 to 5 illustrate display examples when the congestion information and the lane information are displayed using the meter display 212. In the present specific example, as illustrated in FIGS. 2 to 5, the presentation control unit 245 causes various information to be displayed in each of a first display area D1, a second display area D2, a third display area D3, a fourth display area D4, and a fifth display area D5 on the meter display 212.

The first display area D1 is an elongated band-shaped area extending in the lateral direction at the top of the display screen of the meter display 212 (hereinafter simply referred to as the “display screen”). The first display area D1 is provided over the entire width of the display screen. In the first display area D1, a status display F1 is displayed.

The status display F1 is a display indicating information corresponding to the execution status of the autonomous steering control. Specifically, during high-speed autonomous driving, as illustrated in FIGS. 2 to 5, the status display F1 with a text display of “HIGH-SPEED AUTONOMOUS DRIVING” is displayed. On the other hand, during the congestion autonomous driving, the status display F1 with a text display of “CONGESTION AUTONOMOUS DRIVING” is displayed. Further, during hands-off driving, the status display F1 with a text display of “HANDS-OFF DRIVING” is displayed.

The second display area D2 is an elongated band-shaped area in an upper portion of the display screen, which is disposed adjacent to the first display area D1 below the first display area D1. The second display area D2 is provided over the entire width of the display screen. In the second display area D2, a short-distance information display F2 is displayed. The short-distance information display F2 is a display indicating traffic information to be noted, such as congestion information, within a predetermined short-distance range (e.g., within 3 km) from the own vehicle.

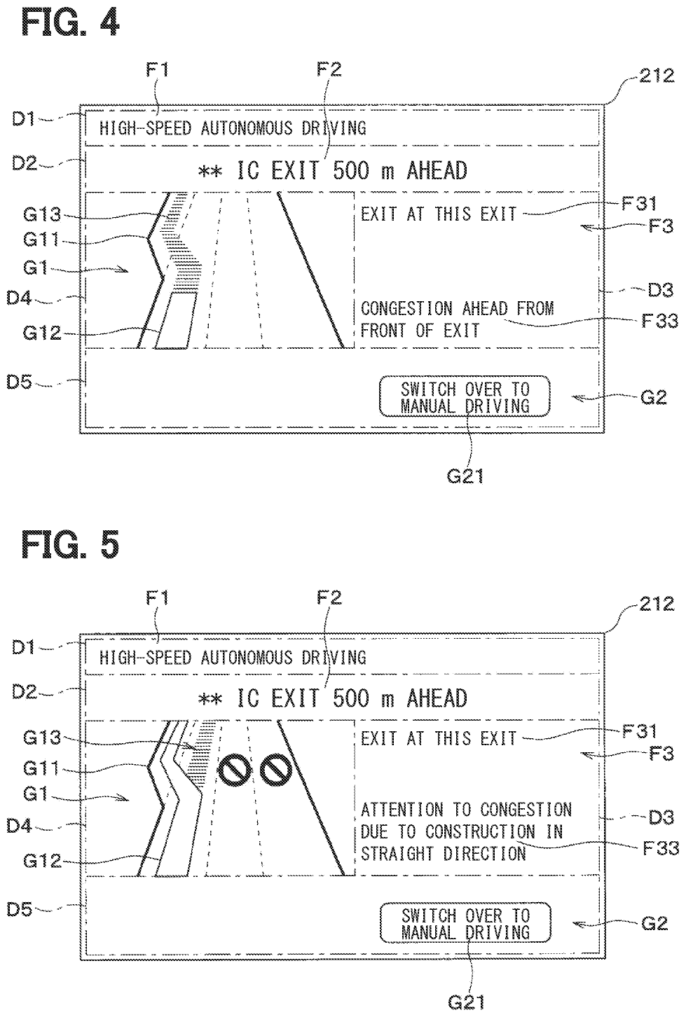

Specifically, for example, when there is a branch 500 m ahead in the proceeding direction of the own vehicle, the short-distance information display F2 with a text display of “BRANCH 500 m AHEAD” is displayed as illustrated in FIG. 2. Further, when there is a branch 500 m ahead in the proceeding direction of the own vehicle and traffic congestion has occurred from the near side of the branch to the branch guidance lane, as illustrated in FIG. 3, the short-distance information display F2 with a text display of “CONGESTION IN FRONT OF BRANCH 500 m AHEAD” is displayed. On the other hand, when there is an exit interchange at which the own vehicle exits from the expressway 500 m ahead in the proceeding direction of the own vehicle, as illustrated in FIGS. 4 and 5, the short-distance information display F2 with a text display of “** IC EXIT 500 m AHEAD” is displayed. “**” stands for the name of an exit interchange.

The third display area D3 is a rectangular area provided on the right side of the display screen and at the center in the vertical direction. The third display area D3 is provided over substantially a half-width of the entire width of the display screen. A main information display F3 is displayed in the third display area D3. The main information display F3 includes a proceeding-direction display F31, an exit information display F32, and an attention information display F33.

The proceeding-direction display F31 is a display indicating the proceeding direction of the own vehicle at the branch or the exit interchange when the short-distance information display F2 concerning the branch or the exit interchange is displayed in the second display area D2. Specifically, for example, a case is assumed where the own vehicle approaches a junction having a branch and goes straight on the main lane road without proceeding to a branch guidance lane at the junction. In this case, as illustrated in FIGS. 2 and 3, the proceeding-direction display F31 with a text display of “GO STRAIGHT AT THIS BRANCH” is displayed. On the other hand, when the own vehicle is approaching the exit interchange, as illustrated in FIGS. 4 and 5, the proceeding-direction display F31 with a text display of “EXIT AT THIS EXIT” is displayed.

The exit information display F32 is a display indicating information concerning the exit interchange. Specifically, the exit information display F32 indicates a traveling distance to the exit interchange and the name of the exit interchange.

The attention information display F33 is a text display indicating traffic congestion and the possibility of a lane change related to the traffic congestion and corresponds to the congestion information and the lane information. Specifically, for example, a scene is assumed in which the own vehicle approaches a junction having a branch, does not proceed to the branch road at the junction, and goes straight on a main lane road having three lanes on each side. It is assumed that an own lane, which is a lane on which the own vehicle is currently traveling, is the first traveling lane closest to the shoulder side, that is, the leftmost side, of the main lane road.

In such an assumed scene, it is assumed that in the main lane road having three lanes on each side on which the own vehicle is traveling, two lanes closer to the center of the road, that is, closer to a median strip, is under traffic restriction due to construction in a place to which the own vehicle is going. It is assumed that traffic congestion has occurred ahead of the own vehicle in the first traveling lane that is the own lane due to the traffic restriction. In this case, as illustrated in FIG. 2, the attention information display F33 with a text display of “CONGESTION DUE TO CONSTRUCTION/IN STRAIGHT FORWARD DIRECTION” is displayed.

In such an assumed situation, it is assumed that traffic congestion has occurred from the front of the branch that the own vehicle is approaching to the branch end, and the end of the traffic congestion has reached the first traveling lane that is the own lane. In this case, as illustrated in FIG. 3, the attention information display F33 with a text display of “CONGESTION IN FRONT OF BRANCH/AVOID CONGESTION?” is displayed.

The fourth display area D4 is a rectangular area provided on the left side of the display screen and at the center in the vertical direction. The fourth display area D4 is provided over substantially a half-width of the entire width of the display screen. In the fourth display area D4, a graphic road display G1 is displayed. The graphic road display G1 is a graphic display indicating traffic congestion and the possibility of a lane change related to the traffic congestion and corresponds to congestion information and lane information. Specifically, the graphic road display G1 includes a graphic lane display G11, a graphic route display G12, and a graphic traffic information display G13.

The graphic lane display G11 is a graphic display indicating lane arrangement and a branch structure in the road width direction within a predetermined short-distance range from the own vehicle, which is a place to which the own vehicle is going on the road on which the own vehicle is currently traveling. The graphic lane display G11 is displayed with perspective such that the proceeding direction of the own vehicle is a direction from the lower side to the upper side of the display screen, and the lane width decreases as the own vehicle moves away from the own vehicle.

The graphic route display G12 is a route guiding figure display indicating the scheduled traveling route of the own vehicle in units of lanes on the graphic lane display G11. The route guiding figure display is a band-shaped or thick line-shaped graphic display drawn along the extending direction of the lane displayed on the graphic lane display G11. The graphic route display G12 indicates the own lane by a front-side portion closest to the own vehicle, that is, the lowermost portion. As illustrated in FIGS. 3 to 5, when a lane change is scheduled in the scheduled traveling route or when a lane change is recommended from the current traffic condition, the graphic route display G12 is displayed in a refractive or branched shape in accordance with the possibility of the lane change.

In the graphic route display G12, a portion corresponding to a normal traveling section in which no traffic congestion has occurred is displayed as the normal display including a normal color and/or a normal pattern. The “normal color” is a color different from a warning color and is, for example, white or black. The “warning color” is a type of color attracting the attention of an observer, that is, the occupant of the own vehicle, and is, for example, red, yellow, or the like. The “warning color” may also be referred to as an “attention color”. The “normal pattern” is a type of pattern different from a warning pattern and is, for example, a continuous pattern such as a solid line or a non-blinking pattern. The “warning pattern” is a type of pattern attracting the attention of the observer and is, for example, an intermittent pattern such as a dotted line or blinking. The “warning pattern” may also be referred to as an “attention pattern”.

On the other hand, in the graphic route display G12, a portion corresponding to the congestion section is displayed as a warning display including the warning color and/or the warning pattern. The graphic route display G12 displayed as a warning also corresponds to the graphic traffic information display G13 to be described later.

The graphic traffic information display G13 is a graphic display indicating traffic information on the graphic lane display G11. For example, as illustrated in FIG. 2, the graphic traffic information display G13 corresponding to the lane restriction due to construction or the like is displayed as a figure similar to a traffic sign for vehicle traffic closure As illustrated in FIGS. 2 to 5, the graphic traffic information display G13 corresponding to a lane during traffic congestion is displayed as a warning display in the graphic route display G12 or a route guiding figure display similar thereto.

The fifth display area D5 is an elongated band-shaped area extending in the lateral direction at the lowermost portion of the display screen. The fifth display area D5 is provided over the entire width of the display screen. In the fifth display area D5, a guidance information display F5 and an operation button display G2 are displayed.

The guidance information display F5 is a text display indicating various guidance information concerning autonomous steering driving. Specifically, for example, when the hands-off driving can be started, the guidance information display F5 displays that the hands-off driving can be started. The same applies to a case where the high-speed autonomous driving or the congestion autonomous driving can be started. When the guidance information display F5 is displayed in the fifth display area D5 together with the operation button display G2, the guidance information display F5 corresponds to input request presentation related to the displayed operation button display G2.

The operation button display G2 is an operation button-like graphic display displayed below the position where the guidance information display F5 is displayed. When the operation button display G2 is displayed in the fifth display area D5 together with the guidance information display F5, the operation button display G2 is disposed adjacent to the guidance information display F5 below the guidance information display F5. At least one operation button display G2 may be displayed or hidden depending on the status. Specifically, for example, as illustrated in FIGS. 2 and 3, a plurality of operation button displays G2 including a first operation button display G21 and a second operation button display G22 can be displayed. Alternatively, as illustrated in FIGS. 4 and 5, only the first operation button display G21 can be displayed.

### SPECIFIC EXAMPLES

Hereinafter, specific examples of information presentation corresponding to various scenes or cases encountered by the own vehicle will be described with reference to FIGS. 2 to 5. In each of the specific examples illustrated in FIGS. 2 to 5, it is assumed that the own vehicle, that is, the in-vehicle system 10, is in high-speed autonomous driving on a main lane road of an expressway having three lanes on each side. Therefore, as illustrated in FIGS. 2 to 5, the presentation control unit 245 causes the status display F1 with a text display of “HIGH-SPEED AUTONOMOUS DRIVING” to be displayed in the first display area D1. In each specific example, not only various information displays on the meter display 212 but also voice output corresponding to the information display is appropriately performed as necessary.

FIG. 2 illustrates an information presentation example under the following conditions when the own vehicle is approaching the end of the traffic congestion that has occurred.
The own vehicle is approaching a junction having a branch during high-speed autonomous driving.
In a scheduled traveling route, the own vehicle does not proceed to the branch road side at the junction and goes straight on the main lane road.
The own vehicle is traveling in the first traveling lane on the leftmost side of the main lane road, that is, on the branch guidance lane side.
In the scheduled traveling route, a lane change from the own lane is not scheduled.
Traffic restrictions are imposed on two lanes closer to the center of the road, that is, closer to a median strip, on the main lane road due to construction, and traffic congestion has occurred in a place to which the own vehicle is going in the own lane.

In this case, the presentation control unit 245 causes the short-distance information display F2 with a text display of “BRANCH 500 m AHEAD” to be displayed in the second display area D2. The presentation control unit 245 causes the proceeding-direction display F31 with a text display of “GO STRAIGHT AT THIS BRANCH”, the exit information display F32, and the attention information display F33 with a text display of “CONGESTION DUE TO CONSTRUCTION/IN STRAIGHT FORWARD DIRECTION” to be displayed in the third display area D3.

Under the above conditions, it is tentatively possible to change lanes to the branch guidance lane that appears on the left side of the own lane, but the lane change is not actually recommended. That is, under the above conditions, it is recommended that traffic congestion corresponding to the congestion section included in the acquired congestion information has occurred in the own lane, and traveling in the own lane is also kept in the congestion section that the own vehicle is currently approaching. Therefore, the presentation control unit 245 presents lane-keeping information as lane information. The “lane-keeping information” is information indicating that it is recommended to keep traveling in the own lane without changing lanes, although it is tentatively possible to safely and easily change lanes.

Specifically, as described above, the presentation control unit 245 causes the following to be displayed in the third display area D3: that the own vehicle will keep the own lane and go straight without changing lanes to the branch guidance lane and that traffic congestion has occurred in the straight direction in a place to which the own vehicle is going. In addition, as illustrated in FIG. 2, the presentation control unit 245 performs the following display on the graphic lane display G11 in the fourth display area D4. That is, the presentation control unit 245 sets a portion on the side away from the own vehicle in the straight graphic route display G12 extending on the own lane as the warning display and causes the portion to be displayed as the graphic traffic information display G13 indicating the congestion section. On the other hand, the presentation control unit 245 does not cause the graphic route display G12 to be displayed in the branch guidance lane. This enables the driver to understand the reason why the lane change control is not performed even when the own vehicle reaches the end of the traffic congestion having occurred in a place to which the own vehicle is going in the own lane.

When the congestion traveling starts, it is possible to switch over from the high-speed autonomous driving to the congestion autonomous driving. Therefore, the presentation control unit 245 causes the guidance information display F5 with a text display of “AUTONOMOUS DRIVING IS ALSO AVAILABLE DURING CONGESTION” to be displayed in the fifth display area D5. The presentation control unit 245 does not cause the first operation button display G21 with a text display of “MANUAL DRIVING” and the second operation button display G22 with a text display of “AUTONOMOUS DRIVING” to be displayed in the fifth display area D5.

In this case, the guidance information display F5 corresponds to input request presentation, that is, input request display, for prompting input operation by selecting one of the first operation button display G21 and the second operation button display G22. In this manner, the presentation control unit 245 performs input request presentation that prompts an input operation corresponding to the presented lane information. The driver can perform an input operation by selecting one of the first operation button display G21 and the second operation button display G22, using the meter switch 213 or a steering switch (not illustrated) provided on the steering wheel 191, for example.

FIG. 3 illustrates an information presentation example when the own vehicle is approaching the end of the traffic congestion under the following conditions.
The own vehicle is approaching a junction having a branch during high-speed autonomous driving.
In a scheduled traveling route, the own vehicle does not proceed to the branch road side at the junction and goes straight on the main lane road.
The own vehicle is traveling in the first traveling lane of the main lane road.
Traffic congestion has occurred in a branch guidance lane and a branch road ahead of the branch guidance lane, and the end of the traffic congestion has reached the own lane. Traffic congestion in the own lane has been resolved in the middle of a parallel traveling section with the branch guidance lane.
No traffic congestion has occurred in the two lanes on the right side of the own lane, that is, on the median strip side.

In this case, the presentation control unit 245 causes the short-distance information display F2 with a text display of “CONGESTION IN FRONT OF BRANCH 500 m AHEAD” to be displayed in the second display area D2. Further, the presentation control unit 245 causes the proceeding-direction display F31 with a text display of “GO STRAIGHT AT THIS BRANCH” and the exit information display F32 to be displayed in the third display area D3.

Under the above conditions, it is possible to temporarily follow traffic congestion while keeping the own lane, or to change lanes to the lane on the right side of the own lane and avoid traffic congestion. That is, under the above conditions, traffic congestion corresponding to the congestion section included in the acquired congestion information has occurred in the own lane, and a lane change to another lane different from the own lane is possible. Therefore, the presentation control unit 245 presents lane change information as lane information. The “lane change information” is information indicating that the lane change can be safely and easily performed and that the lane change is recommended.

Specifically, as illustrated in FIG. 3, the presentation control unit 245 causes the graphic traffic information display G13 indicating the congestion section to be displayed in the branch guidance lane. The presentation control unit 245 causes the end on the near side in the graphic traffic information display G13 indicating the congestion section extending from the branch guidance lane to be displayed at an intermediate position in the straight graphic route display G12 extending on the own lane. In the graphic route display G12 on the own lane, the intermediate portion corresponding to the end of the traffic congestion is displayed as a warning as the graphic traffic information display G13 indicating the congestion section, and the remaining portion is displayed normally. Thereby, the driver can recognize that the traffic congestion in the own lane is temporary and the traffic congestion in the own lane has been resolved in the middle of the parallel traveling section with the branch guidance lane.

Moreover, the presentation control unit 245 performs the following display on the graphic lane display G11 in the fourth display area D4. That is, the presentation control unit 245 causes an arrow-shaped route guiding figure display, extending right-forward from the proceeding-side end of the normal display portion on the near side in the graphic route display G12, to be displayed as an additional graphic route display G12 indicating the lane change possibility The presentation control unit 245 causes the attention information display F33 with a text display of “CONGESTION IN FRONT OF BRANCH/AVOID CONGESTION?” to be displayed in the third display area D3. Thereby, the driver can recognize that the end of the traffic congestion reaching a place to which the own vehicle is going in the own lane can be avoided by the lane change.

In the present embodiment, whether to change lanes and avoid the traffic congestion or to travel following the traffic congestion without changing lanes is determined by an input operation for approval by the driver. Therefore, the presentation control unit 245 causes the first operation button display G21 with a text display of “FOLLOW CONGESTION” and the second operation button display G22 with a text display of “APPROVE AVOIDING CONGESTION” to be displayed in the fifth display area D5. In this case, the attention information display F33 corresponds to input request presentation that prompts the selection of one of the first operation button display G21 and the second operation button display G22 for an input operation. In this manner, the presentation control unit 245 performs input request presentation that prompts an input operation corresponding to the presented lane information.

In the specific examples of FIGS. 2 and 3, the driver grasps the traffic status around the own vehicle to a predetermined extent upon the input operation using the operation button display G2. Therefore, the second task control unit 247 restricts the use of the second task from the start of the display of the operation button display G2 until the reception of the input operation by the operation reception unit 246. Specifically, for example, the second task control unit 247 reduces the display area of the second task content on the CID display 221 and displays a message prompting a front gaze and an input operation in a conspicuous manner. Alternatively, for example, the second task control unit 247 temporarily stops the use of the second task.

FIG. 4 illustrates an information presentation example when the own vehicle is approaching the end of the traffic congestion under the following conditions.
The own vehicle is approaching an exit interchange.
The own vehicle is traveling in the first traveling lane of the main lane road.
Traffic congestion has occurred in a branch guidance lane for exiting the expressway at the exit interchange, and the end of the traffic congestion has reached the own lane. Traffic congestion in the own lane has been resolved in the middle of a parallel traveling section with the branch guidance lane.
No traffic congestion has occurred in the two lanes on the right side of the own lane, that is, the second traveling lane and the overtaking lane.

In this case, the presentation control unit 245 causes the short-distance information display F2 with a text display of “** IC EXIT 500 m AHEAD” to be displayed in the second display area D2. The presentation control unit 245 causes the proceeding-direction display F31 with a text display of “EXIT AT THIS EXIT” and the attention information display F33 with a text display of “CONGESTION AHEAD FROM FRONT OF EXIT” to be displayed in the third display area D3.

Under the above conditions, it is tentatively possible to change lanes to another lane on the right side of the own lane, but the lane change is not actually recommended. That is, under the above conditions, it is recommended that traffic congestion corresponding to the congestion section included in the acquired congestion information has occurred in the own lane, and traveling in the own lane is also kept in the congestion section that the own vehicle is currently approaching. Therefore, the presentation control unit 245 presents lane-keeping information as lane information.

Specifically, as illustrated in FIG. 4, the presentation control unit 245 performs the following display on the graphic lane display G11 in the fourth display area D4. That is, the presentation control unit 245 causes the graphic route display G12 extending from the own lane to the branch guidance lane to be displayed. Here, the presentation control unit 245 sets a portion displaying the own lane on the near side in the graphic route display G12 as the normal display. On the other hand, the presentation control unit 245 sets a portion on the side closer to a place to which the own vehicle is going than the normal display portion in the graphic route display G12 as warning display and causes the portion to be displayed as the graphic traffic information display G13 indicating the congestion section. This enables the driver to understand the reason why the lane change control is not performed even when the own vehicle reaches the end of the traffic congestion having occurred in a place to which the own vehicle is going in the own lane.

In the example of FIG. 4, the lane change from the own lane to the branch guidance lane during traffic congestion is set in advance on the scheduled traveling route. That is, such a lane change is not an unscheduled lane change. Therefore, in the example of FIG. 4, the message for lane change approval and the operation button display G2 are not displayed.

FIG. 5 illustrates an information presentation example when the own vehicle is approaching the end of the traffic congestion under the following conditions.
The own vehicle is approaching an exit interchange.
The own vehicle is traveling in the first traveling lane of the main lane road.
Traffic lane restriction due to construction is being performed after a parallel traveling section with the branch guidance lane in the main lane road, and this has caused traffic congestion. The end of the traffic congestion has reached the parallel traveling section with the branch guidance lane ahead of the own vehicle in the own lane.

In this case, the presentation control unit 245 causes the short-distance information display F2 with a text display of “** IC EXIT 500 m AHEAD” to be displayed in the second display area D2. The presentation control unit 245 causes the proceeding-direction display F31 with a text display of “EXIT AT THIS EXIT” and the attention information display F33 with a text display of “ATTENTION TO CONGESTION DUE TO CONSTRUCTION IN STRAIGHT DIRECTION” to be displayed in the third display area D3.

Under the above conditions, the own vehicle is scheduled to change lanes to the branch guidance lane side before reaching the end of the traffic congestion. That is, under the above conditions, traffic congestion corresponding to the congestion section included in the acquired congestion information has occurred in the own lane, and a lane change to another lane different from the own lane is possible. Therefore, the presentation control unit 245 presents lane change information as lane information. That is, the presentation control unit 245 causes the graphic route display G12 to be displayed in the fourth display area D4 as the normal display, the graphic route display G12 indicating that the own vehicle changes lanes from the own lane to the branch guidance lane and proceeds in the branch guidance lane.

However, there is a possibility that the position of the end of the traffic congestion will change before the own vehicle changes lanes to the branch guidance lane side. Therefore, the presentation control unit 245 performs the following display on the graphic lane display G11 in the fourth display area D4. That is, the presentation control unit 245 causes the graphic traffic information display G13 indicating the congestion section to be displayed in the parallel traveling section with the branch guidance lane in the own lane. As a result, the graphic traffic information display G13 indicating the congestion section is displayed at a position on the side away from the own vehicle in the own lane. The presentation control unit 245 causes the graphic traffic information display G13 having a figure similar to that of a traffic sign for vehicle traffic closure to be displayed at a position corresponding to a lane in which traffic is restricted.

In the examples of FIGS. 4 and 5, the continuation condition for the autonomous driving is not satisfied due to the exit from the expressway, and it becomes necessary to switch over to the manual driving. Therefore, the presentation control unit 245 causes the first operation button display G21 with a text display of “SWITCH OVER TO MANUAL DRIVING” to be displayed in the fifth display area D5.

### Operation Example

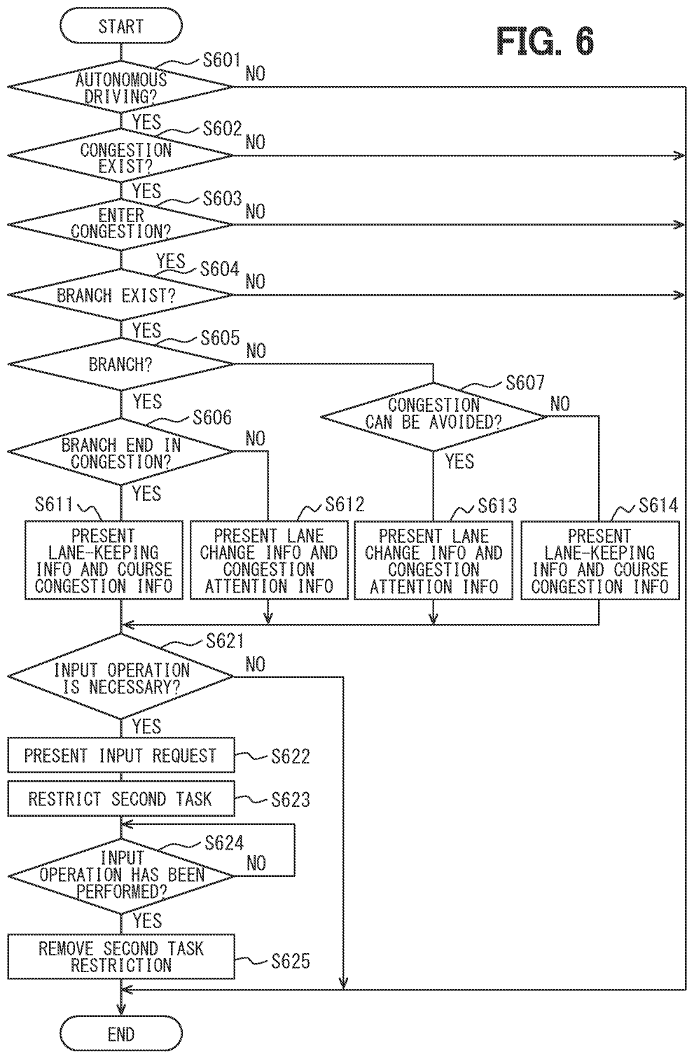

One specific example of the control operation or the control method and the control program corresponding thereto described above will be described with reference to flowcharts illustrated in FIG. 6. In the illustrated flowchart, “S” stands for “step”.

The flowchart illustrated in FIG. 6 illustrates a flow of an information presentation operation concerning a lane change during autonomous driving by the CPU in the HMI control device 24. Hereinafter, the CPU in the HMI control device 24 is simply referred to as “CPU”.

First, in S601, the CPU determines whether or not autonomous driving is currently being performed. When the own vehicle is not currently in autonomous driving (i.e., S601: NO), the CPU skips all the processing after S602 and terminates this operation. On the other hand, when the own vehicle is currently in autonomous driving (i.e., S601: YES), the CPU advances the processing to S602.

In S602, the CPU determines whether or not traffic congestion has occurred in a place to which the own vehicle is going. When no traffic congestion has occurred in a place to which the own vehicle is going (i.e., S602: NO), the CPU skips all the processing after S603 and terminates this operation. On the other hand, when traffic congestion has occurred in a place to which the own vehicle is going (i.e., S602: YES), the CPU advances the processing to S603.

In S603, the CPU determines the status of entry of the own vehicle into the congestion section included in the acquired congestion information. That is, the CPU determines whether or not the own vehicle has entered the congestion section. The entry status can be determined on the basis of, for example, all or some of the current position of the own vehicle, congestion information, the distance between the own vehicle and a preceding vehicle, a decrease in the vehicle speed of the own vehicle and/or the preceding vehicle, turning on of a hazard lamp of the preceding vehicle, and the like. When the entry status is not the entry of the own vehicle into the congestion section (i.e., S603: NO), the CPU skips all the processing after S604 and terminates this operation. On the other hand, when the entry status is the entry of the own vehicle into the congestion section (i.e., S603: YES), the CPU advances the processing to S604.

In S604, the CPU determines whether or not there is a branch in the congestion section. The term “branch” as used herein includes both a branch with a branch road at an interchange and a branch at a junction. In the determination in S604, unlike S605 to be described later, it does not matter whether the own vehicle is scheduled to proceed in the branch guidance lane or the main lane road at such a branch.

When there is no branch in the congestion section (i.e., S604: NO), the CPU skips all the processing after S605 and terminates this operation. On the other hand, when there is a branch in the congestion section (i.e., S604: YES), the CPU advances the processing to S605.

In S605, the CPU determines whether the own vehicle is scheduled to proceed to the branch road side or is scheduled to proceed to the main lane road at the branch determined to exist in S604. When the own vehicle is scheduled to proceed to the branch road side (i.e., S605: YES), the CPU advances the processing to S606. On the other hand, when the own vehicle is scheduled to proceed on the main lane road (i.e., S605: NO), the CPU advances the processing to S607.

In S606, the CPU determines whether or not the branch end is congested. When the branch end is congested (i.e., S606: YES), the CPU advances the processing to S611. On the other hand, when the branch end is not congested (i.e., S606: NO), the CPU advances the processing to S612.

In S607, the CPU determines whether or not the traffic congestion can be avoided by a lane change. When the traffic congestion can be avoided (i.e., S607: YES), the CPU advances the processing to S613. On the other hand, when the traffic congestion cannot be avoided (i.e., S607: NO), the CPU advances the processing to S614.

As described above, in the present embodiment, the CPU presents information concerning traffic congestion, a branch, and a lane change in accordance with whether or not the own vehicle proceeds to the branch road side, whether or not the branch end is congested, and whether or not the traffic congestion can be avoided.

Specifically, for example, when traffic congestion has occurred from the branch guidance lane to the own lane, and the own vehicle will queue up at the end of the traffic congestion in order to proceed to the branch guidance lane side, the CPU performs the processing of S611. In S611, the CPU presents lane-keeping information and course congestion information by the HMI device 20 as illustrated in FIG. 4. The lane-keeping information corresponds to display in which the graphic route display G12 that is the route guiding figure display of the normal display and a portion on the own lane in the graphic traffic information display G13 that is the route guiding figure display of the warning display in FIG. 4 are continuous on the own lane. With this display, it is possible to display that the own vehicle will queue up at the end of the traffic congestion that has reached the own lane from the branch guidance lane. The “course congestion information” is congestion information corresponding to a congestion section that is a place to which the own vehicle is going on the scheduled traveling route and in which the own vehicle needs to travel. The course congestion information corresponds to the graphic traffic information display G13 and the attention information display F33 of “CONGESTION AHEAD FROM FRONT OF EXIT” in FIG. 4.

When the own vehicle proceeds from the own lane where traffic congestion has occurred ahead to the branch guidance lane where no traffic congestion has occurred, the CPU performs the processing of S612. In S612, the CPU presents the lane change information and the congestion attention information by the HMI device 20 as illustrated in FIG. 5. The lane change information corresponds to the graphic route display G12 of the normal display in FIG. 5, indicating that that the own vehicle changes lanes from the own lane to the branch guidance lane and proceeds in the branch guidance lane. The “congestion attention information” is congestion information different from the above course congestion information, and is information for calling attention to that traffic congestion has occurred ahead of the own vehicle. The congestion attention information corresponds to the attention information display F33 of “ATTENTION TO CONGESTION DUE TO CONSTRUCTION IN STRAIGHT DIRECTION” in FIG. 5 and the graphic traffic information display G13 indicating the congestion section displayed in the parallel traveling section with the branch guidance lane in the own lane.

When the own vehicle does not proceed to the branch guidance lane and changes lanes to another main lane road on which no traffic congestion has occurred to avoid traffic congestion although the traffic congestion has occurred from the branch guidance lane to the own lane, the CPU performs the processing of S613. In S613, the CPU presents the lane change information and the congestion attention information by the HMI device 20 as illustrated in FIG. 3. The lane change information corresponds to the additional graphic route display G12 of the arrow shape extending right-forward in FIG. 3. The congestion attention information corresponds to the attention information display F33 of “CONGESTION IN FRONT OF BRANCH” and the graphic traffic information display G13 indicating the congestion section from the branch guidance lane to the own lane in FIG. 3.

When traffic congestion has occurred in front of the own lane while the own vehicle is traveling on the main lane road, and it is substantially impossible to avoid the traffic congestion by a lane change according to the current scheduled traveling route, the CPU performs the processing of S614. In S614, the CPU presents lane-keeping information and course congestion information by the HMI device 20 as illustrated in FIG. 2. The lane-keeping information corresponds to the route guiding figure display indicating that the own vehicle will queue up at the end of the traffic congestion occurring in the own lane by the continuation of the graphic route display G12 and the graphic traffic information display G13 in FIG. 2. The course congestion information corresponds to the attention information display F33 of “CONGESTION DUE TO CONSTRUCTION/IN STRAIGHT FORWARD DIRECTION” and the graphic traffic information display G13 of the warning display indicating the congestion section in accordance with the graphic route display G12 in FIG. 2.

After performing the processing of any of S611 to S614, the CPU advances the processing to S621. In S621, the CPU determines whether or not an input operation using the operation button display G2 is required.

When the input operation using the operation button display G2 is not required (i.e., S621: NO), the CPU skips all the processing of S622 and the subsequent steps and terminates this operation. On the other hand, when an input operation using the operation button display G2 is required (i.e., S621: YES), the CPU advances the processing to and after S622.

In S622, the CPU presents the input request presentation by the HMI device 20. The input request presentation corresponds to the guidance information display F5 of “AUTONOMOUS DRIVING IS ALSO AVAILABLE DURING CONGESTION” in FIG. 2 and the attention information display F33 of “WILL YOU AVOID CONGESTION?” in FIG. 3.

In S623, the CPU starts the usage restriction of the second task. Subsequently, the CPU performs the processing of S624. In S624, the CPU determines whether or not the input operation corresponding to the operation button display G2 has been received. Until the input operation is received, the CPU waits for the processing to proceed to S625 and repeats the processing of S624. When the input operation is received, in S625, the CPU removes, that is, terminates, the usage restriction of the second task. In this way, the use of the second task is restricted from the start of the display of the operation button display G2 until the input operation is received by the operation reception unit 246.

### Second Embodiment

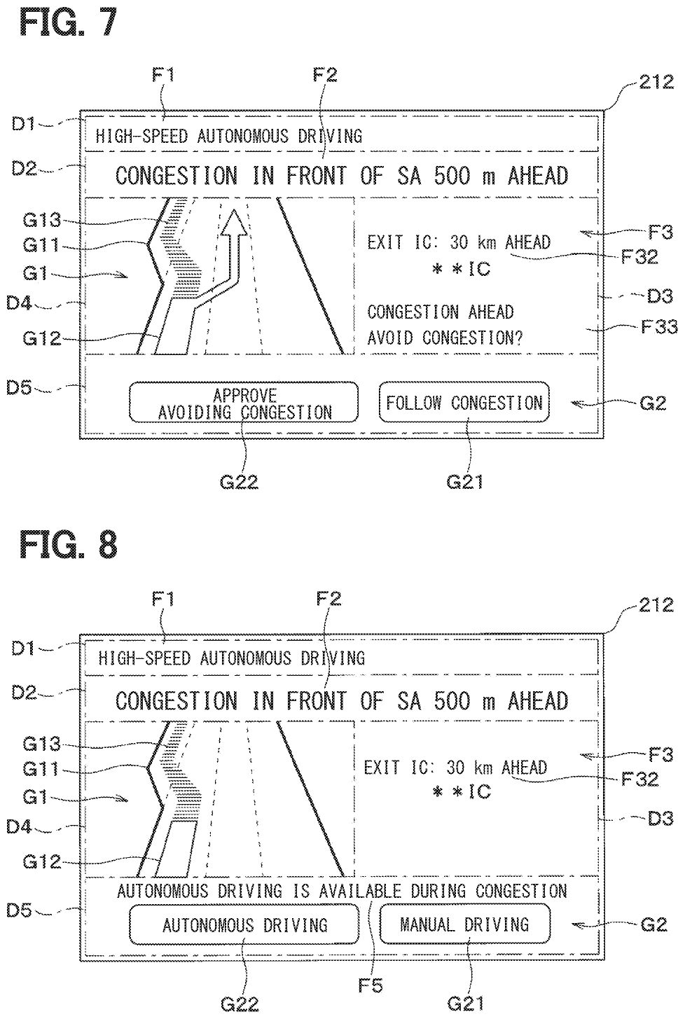

Hereinafter, a second embodiment will be described with reference to FIGS. 7 to 10 in addition to FIG. 1. In the following description of the second embodiment, portions different from those of the first embodiment will be mainly described. In the first embodiment and the second embodiment, the same or equivalent portions are denoted by the same reference numerals. Therefore, in the following description of the second embodiment, with respect to constituent elements having the same reference numerals as those in the first embodiment, the description in the first embodiment can be appropriately incorporated unless there is a technical contradiction or a special additional description. The same applies to a third embodiment described later.

FIG. 7 illustrates an example in which high-speed autonomous driving is being performed on a main lane road of an expressway having three lanes on each side, traffic congestion has occurred in a branch guidance lane to a service area set to stop by on a scheduled traveling route, and the end of the traffic congestion has reached the own lane. At present, there is a distance of about 500 m to the end of the traffic congestion, so that it is possible to select whether to stop at the service area as scheduled or to cancel the stop at the service area in order to avoid the traffic congestion.

Such selection is adapted to artificial selection corresponding to the preference or circumstances of the occupant including the driver rather than automatic selection by the in-vehicle system 10. Specifically, for example, when the occupant intends to arrive at the destination as soon as possible, stopover to the service area is canceled. On the other hand, when there is a request for taking a break or having a meal outside the vehicle, stopover to the nearby service area can be selected even when there is slight traffic congestion. Therefore, the presentation control unit 245 performs the following information presentation control.

In the second display area D2, the presentation control unit 245 causes the short-distance information display F2 of “CONGESTION IN FRONT OF SA 500 m AHEAD” to be displayed. The presentation control unit 245 causes the attention information display F33 of “CONGESTION AHEAD/AVOID CONGESTION?” to be displayed in the third display area D3.

In the fourth display area D4, the presentation control unit 245 causes the graphic route display G12 extending from the own lane to the branch guidance lane to be displayed. Here, the presentation control unit 245 sets a portion on the near side in the graphic route display G12 as the normal display. On the other hand, the presentation control unit 245 sets a portion on the side closer to a place to which the own vehicle is going than the normal display portion in the graphic route display G12 as warning display and causes the portion to be displayed as the graphic traffic information display G13 indicating the congestion section. Furthermore, the presentation control unit 245 causes an arrow-like figure, extending right-forward from the proceeding-direction side end of the normal display portion on the near side in the graphic route display G12, to be displayed as the normal display as an additional graphic route display G12 indicating the lane change possibility.

Therefore, the presentation control unit 245 causes the first operation button display G21 with a text display of “FOLLOW CONGESTION” and the second operation button display G22 with a text display of “APPROVE AVOIDING CONGESTION” to be displayed in the fifth display area D5. When the occupant of the own vehicle such as the driver selects “FOLLOW CONGESTION”, the presentation control unit 245 changes the display of the meter display 212 from FIG. 7 to FIG. 8.

In FIG. 8, the attention information display F33 and the arrow-like additional graphic route display G12 indicating the lane change possibility are deleted. On the other hand, in the second display area D2, the presentation control unit 245 causes the short-distance information display F2 of “CONGESTION IN FRONT OF SA 500 m AHEAD” to be displayed. The presentation control unit 245 does not cause the first operation button display G21 with a text display of “MANUAL DRIVING” and the second operation button display G22 with a text display of “AUTONOMOUS DRIVING” to be displayed in the fifth display area D5. Therefore, the presentation control unit 245 causes the guidance information display F5 of “AUTONOMOUS DRIVING IS ALSO AVAILABLE DURING CONGESTION” to be displayed in the fifth display area D5.

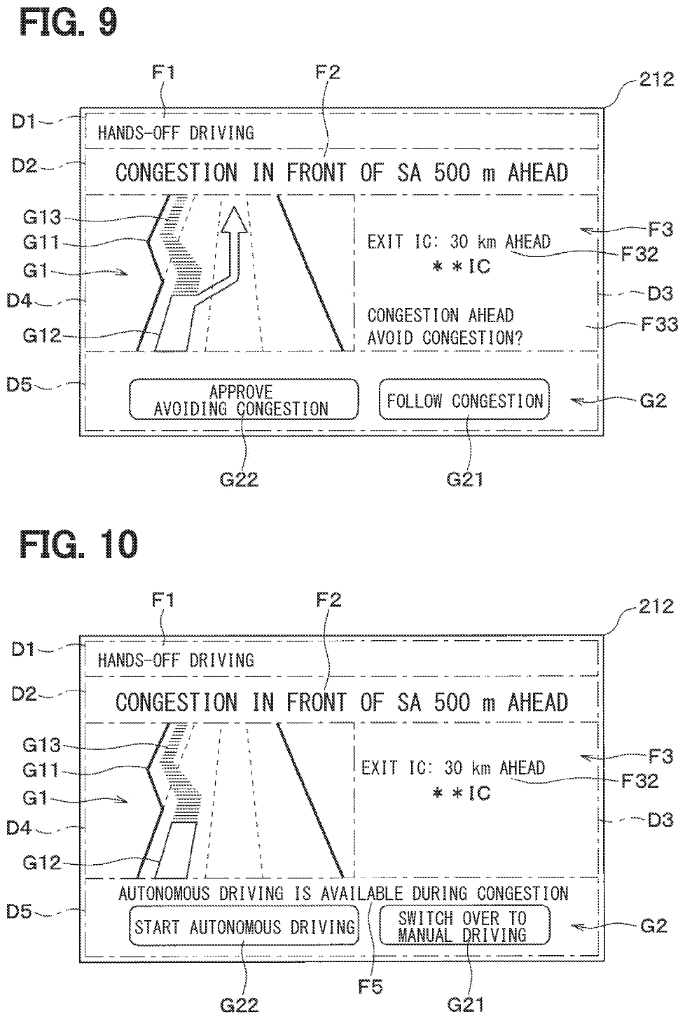

FIG. 9 illustrates an example similar to FIG. 7 during hands-off driving. The difference between FIG. 9 and FIG. 7 is only the display content of the status display F1 in the first display area D1.

For example, there may be a case where traffic restriction due to construction or an accident is performed in a part of a traveling section where high-speed autonomous driving is possible on an expressway. In such a case, the start condition or the continuation condition for the high-speed autonomous driving is not satisfied, and the high-speed autonomous driving becomes unavailable while the hands-off driving becomes available. On the other hand, when the congestion traveling is started during hands-off driving, the congestion autonomous driving may become available.

When the occupant of the own vehicle such as the driver selects “FOLLOW CONGESTION” during the screen display of FIG. 9, the presentation control unit 245 changes the display of the meter display 212 from FIG. 9 to FIG. 10. In FIG. 10 as well, the attention information display F33 and the arrow-like additional graphic route display G12 indicating the lane change possibility are deleted. Further, in the second display area D2, the presentation control unit 245 causes the short-distance information display F2 of “CONGESTION IN FRONT OF SA 500 m AHEAD” to be displayed. On the other hand, the presentation control unit 245 does not cause the first operation button display G21 with a text display of “SWITCH OVER TO MANUAL DRIVING” and the second operation button display G22 with a text display of “START AUTONOMOUS DRIVING” to be displayed in the fifth display area D5. Moreover, the presentation control unit 245 causes the guidance information display F5 of “AUTONOMOUS DRIVING IS AVAILABLE DURING CONGESTION” to be displayed in the fifth display area D5.

### Third Embodiment

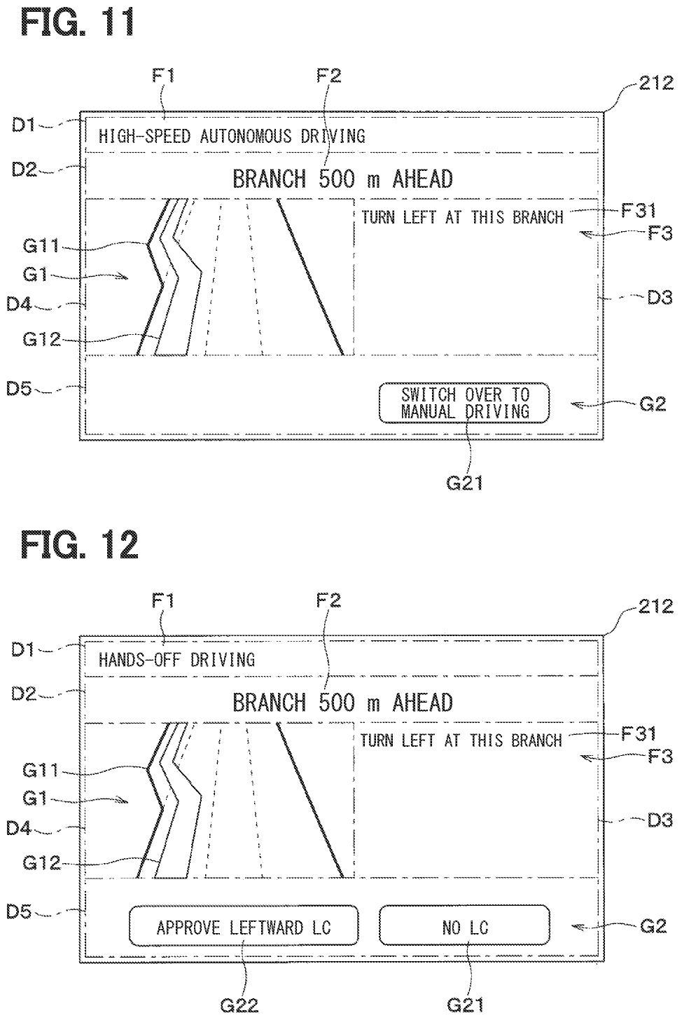

Hereinafter, a third embodiment will be described with reference to FIGS. 11 to 22 in addition to FIG. 1. The present embodiment illustrates various instances that can be encountered during the approach to a junction having a branch. In each of the examples of FIGS. 11 to 22, it is assumed that, in a main lane road having three lanes on each side, the own lane is the leftmost first traveling lane, that is, the traveling lane on the side farthest from a median strip.

(1) Own Lane=Non-Traffic Congestion/Lane Change Required/Lane Change Destination=Non-Traffic Congestion

FIGS. 11 and 12 illustrate an example in which the own lane is not congested, a lane change to the branch guidance lane side is necessary according to the scheduled traveling route, and the branch guidance lane as the lane change destination is not congested. FIG. 11 illustrates a case during high-speed autonomous driving, and FIG. 12 illustrates a case during hands-off driving. In these cases, the presentation control unit 245 presents the lane change information.

Specifically, as illustrated in FIGS. 11 and 12, the presentation control unit 245 causes the short-distance information display F2 of “BRANCH 500 m AHEAD” to be displayed in the second display area D2. The presentation control unit 245 causes the proceeding-direction display F31 of “TURN LEFT AT THIS BRANCH” to be displayed in the third display area D3. Moreover, the presentation control unit 245 causes the graphic route display G12, changing lanes from the own lane and extending to the branch guidance lane, to be displayed as the normal display in the fourth display area D4.

During high-speed autonomous driving, it is possible to arbitrarily switch over to manual driving as soon as the driver prepares for a driving switch. Therefore, as illustrated in FIG. 11, the presentation control unit 245 causes the first operation button display G21 with a text display of “SWITCH OVER TO MANUAL DRIVING” to be displayed in the fifth display area D5. In this case, the input operation corresponding to the first operation button display G21 is optional. Therefore, in this example, the usage restriction of the second task during a wait for the input operation corresponding to the first operation button display G21, is not performed.

During hands-off driving, the driver's approval may be required for a lane change from the own lane in the main lane road to the branch guidance lane. Therefore, as illustrated in FIG. 12, the presentation control unit 245 causes the first operation button display G21 with a text display of “NOT LC” and a second operation button display G22 with a text display of “APPROVE LEFTWARD LC” to be displayed in the fifth display area D5. LC stands for lane change.

(2) Own Lane=Non-Traffic Congestion/Lane Change Required/Lane Change Destination=Traffic Congestion

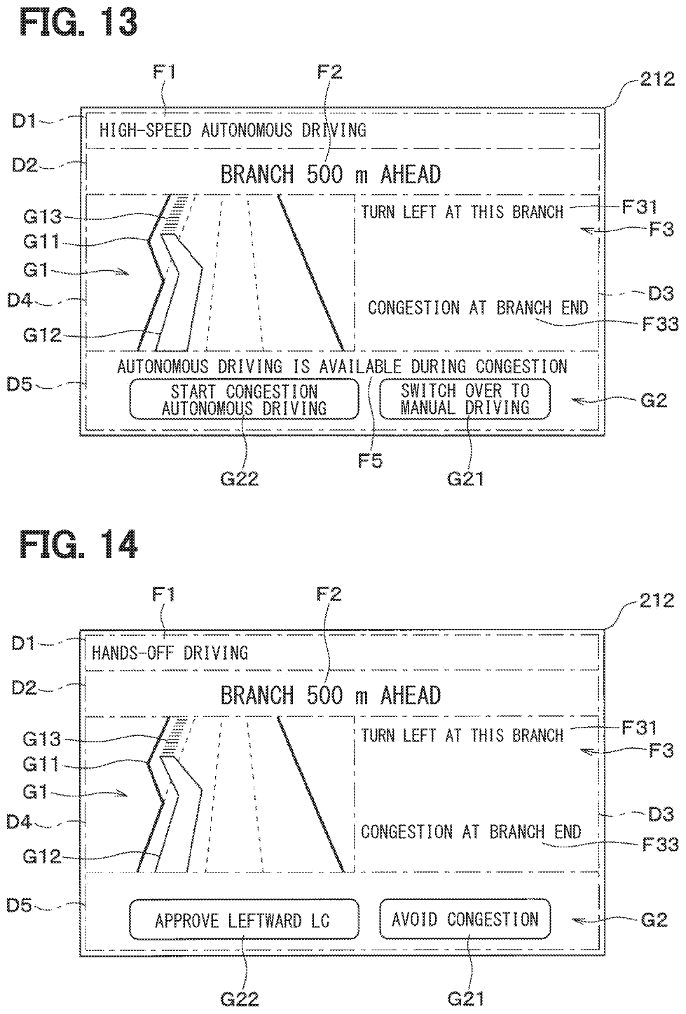

FIGS. 13 and 14 illustrate an example in which the own lane is not congested, a lane change to the branch guidance lane side is necessary according to the scheduled traveling route, and the branch guidance lane as the lane change destination is congested. FIG. 13 illustrates a case during high-speed autonomous driving, and FIG. 14 illustrates a case during hands-off driving. In this example, the display contents of the short-distance information display F2 and the proceeding-direction display F31 are similar to those in FIGS. 11 and 12.

In this example, the own vehicle attempts to take behavior of changing lanes from the own lane that is not congested to the branch guidance lane that is congested and queueing up at the end of the traffic congestion. In other words, this example corresponds to a case where traffic congestion corresponding to the congestion section included in the acquired congestion information has occurred in another lane different from the own lane, and it is recommended to change lanes from the own lane to another lane and perform the congestion traveling. Therefore, the presentation control unit 245 presents lane change information and course congestion information.

Specifically, as illustrated in FIGS. 13 and 14, the presentation control unit 245 causes the attention information display F33 of “CONGESTED AT BRANCH END” to be displayed in the third display area D3. In this example, the end of the traffic congestion occurring in the branch guidance lane has not reached the own lane. Therefore, the presentation control unit 245 performs the following display on the graphic lane display G11 in the fourth display area D4. That is, the presentation control unit 245 causes the graphic traffic information display G13 indicating the congestion section to be displayed in the branch guidance lane. Further, the presentation control unit 245 causes the graphic route display G12, changing lanes from the own lane and reaching the end of the traffic congestion in the branch guidance lane, to be displayed as the normal display.

When the congestion traveling starts in the branch guidance lane, it is possible to switch over from high-speed autonomous driving to congestion autonomous driving. Therefore, as illustrated in FIG. 13, the presentation control unit 245 causes the guidance information display F5 of “AUTONOMOUS DRIVING IS ALSO AVAILABLE DURING CONGESTION” to be displayed in the fifth display area D5. The presentation control unit 245 does not cause the first operation button display G21 with a text display of “SWITCH OVER TO MANUAL DRIVING” and the second operation button display G22 with a text display of “START CONGESTION AUTONOMOUS DRIVING” to be displayed in the fifth display area D5.

During hands-off driving, the driver's approval may be required for a lane change from the own lane in the main lane road to the branch guidance lane. On the other hand, there may be an option of recalculating the scheduled traveling route while traveling straight on the branch that the own vehicle is approaching to avoid traffic congestion. Therefore, as illustrated in FIG. 14, the presentation control unit 245 causes the first operation button display G21 with a text display of “AVOID CONGESTION” and the second operation button display G22 with a text display of “APPROVE LEFTWARD LC” to be displayed in the fifth display area D5.

(3) Own Lane=Traffic Congestion/No Lane Change

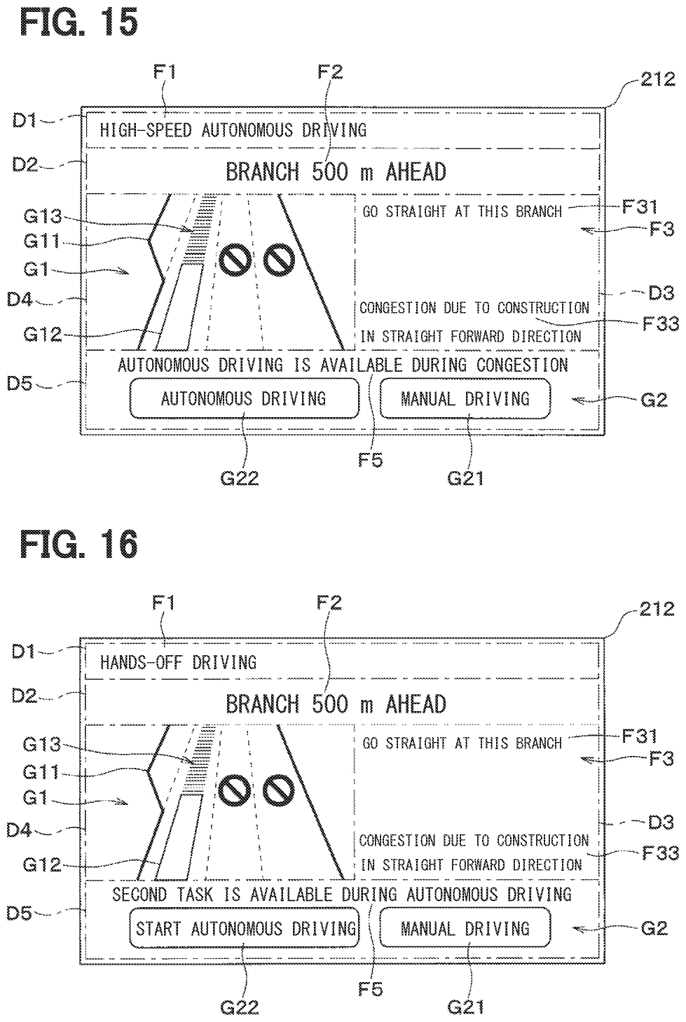

FIGS. 15 and 16 illustrate an example in which a place to which the own vehicle is going in the own lane is congested and a lane change to the branch guidance lane side is not scheduled according to the scheduled traveling route. FIG. 15 illustrates a case during high-speed autonomous driving, and FIG. 16 illustrates a case during hands-off driving.

In this example, the own vehicle attempts to take behavior of queueing up at the end of the traffic congestion in the own lane where traffic congestion has occurred and where the own vehicle is going without changing lanes. Therefore, the presentation control unit 245 presents lane-keeping information and congestion attention information.

Specifically, as illustrated in FIGS. 15 and 16, the presentation control unit 245 causes the short-distance information display F2 of “BRANCH 500 m AHEAD” to be displayed in the second display area D2. The presentation control unit 245 causes the proceeding-direction display F31 of “GO STRAIGHT AT THIS BRANCH” and the attention information display F33 of “CONGESTION DUE TO CONSTRUCTION/IN STRAIGHT FORWARD DIRECTION” to be displayed in the third display area D3.

In the fourth display area D4, the presentation control unit 245 performs the following display on the graphic lane display G11. That is, the presentation control unit 245 sets a portion on the side away from the own vehicle in the straight graphic route display G12 extending on the own lane as the warning display and causes the portion to be displayed as the graphic traffic information display G13 indicating the congestion section. The presentation control unit 245 causes the graphic traffic information display G13 having a figure similar to that of a traffic sign for vehicle traffic closure to be displayed at a position corresponding to a lane in which traffic is restricted. On the other hand, the presentation control unit 245 does not cause the graphic route display G12 to be displayed in the branch guidance lane.

The autonomous driving can be continued even when the congestion traveling is started during the traveling in the specific section where the high-speed autonomous driving is possible. Further, even when such traffic congestion is resolved during the traveling in the specific section, the autonomous driving can be continued. On the other hand, there is also an option of switching over to manual driving in order to avoid traffic congestion, proceed to the branch guidance lane side, and travel on another route different from the current scheduled traveling route,

Therefore, as illustrated in FIG. 15, the presentation control unit 245 causes the guidance information display F5 of “AUTONOMOUS DRIVING IS ALSO AVAILABLE DURING CONGESTION” to be displayed in the fifth display area D5. The presentation control unit 245 does not cause the first operation button display G21 with a text display of “MANUAL DRIVING” and the second operation button display G22 with a text display of “AUTONOMOUS DRIVING” to be displayed in the fifth display area D5.

During hands-off driving, the autonomous driving can be started by the start of the congestion traveling. The start of the autonomous driving enables the use of the second task. On the other hand, there is also an option of switching over to manual driving in order to avoid traffic congestion, proceed to the branch guidance lane side, and travel on another route different from the current scheduled traveling route,

Therefore, as illustrated in FIG. 16, the presentation control unit 245 causes the guidance information display F5 of “SECOND TASK IS AVAILABLE DURING AUTONOMOUS DRIVING” to be displayed in the fifth display area D5. The presentation control unit 245 does not cause the first operation button display G21 with a text display of “MANUAL DRIVING” and the second operation button display G22 with a text display of “START AUTONOMOUS DRIVING” to be displayed in the fifth display area D5.

(4) Own Lane=Traffic Congestion/Lane Change Required/Lane Change Destination=Non-Traffic Congestion

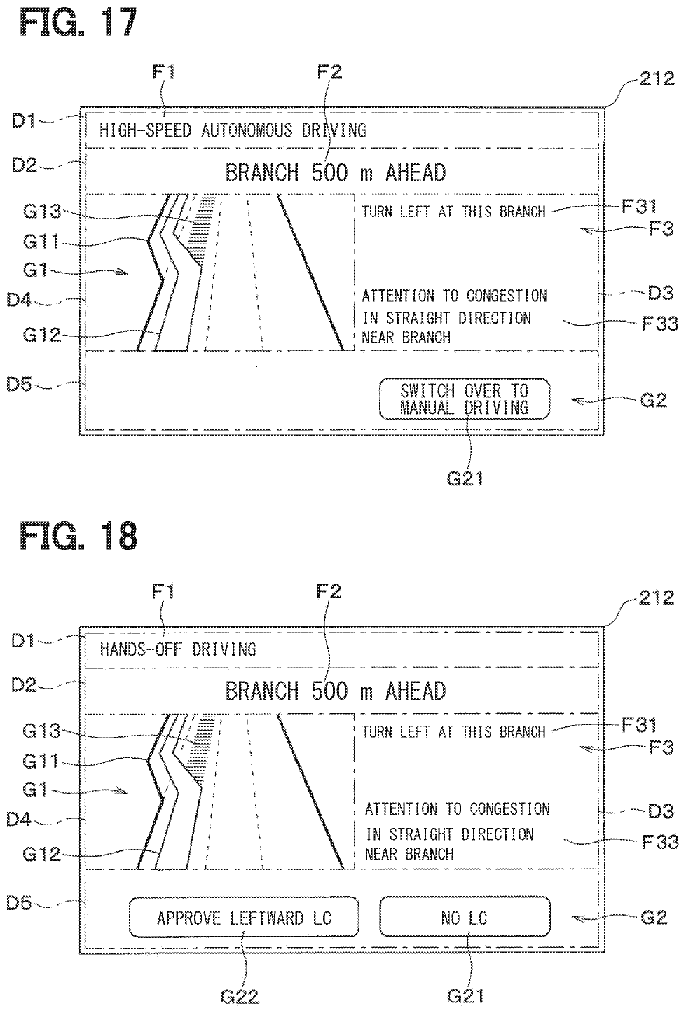

FIGS. 17 and 18 illustrate an example in which a place to which the own vehicle is going in the own lane is congested, a lane change to the branch guidance lane side is necessary according to the scheduled traveling route, and the branch guidance lane as the lane change destination is not congested. FIG. 17 illustrates a case during high-speed autonomous driving, and FIG. 18 illustrates a case during hands-off driving. In this example, the display contents of the short-distance information display F2 and the proceeding-direction display F31 are similar to those in FIGS. 11 and 12.

In this example, the own vehicle is scheduled to change lanes to the branch guidance lane side before reaching the end of the traffic congestion in the own lane. At the time of the lane change, the driver is required to pay a certain degree of attention to the status of the end of the traffic congestion that the own vehicle is currently approaching. Therefore, the presentation control unit 245 presents lane change information and congestion attention information.

Specifically, as illustrated in FIGS. 17 and 18, the presentation control unit 245 causes the attention information display F33 of “ATTENTION TO CONGESTION/IN STRAIGHT DIRECTION NEAR BRANCH” to be displayed in the third display area D3. The presentation control unit 245 performs the following display on the graphic lane display G11 in the fourth display area D4. That is, the presentation control unit 245 causes the graphic route display G12 to be displayed as the normal display, the graphic route display G12 indicating that the own vehicle changes lanes from the own lane to the branch guidance lane and proceeds in the branch guidance lane. The presentation control unit 245 causes the graphic traffic information display G13 indicating the congestion section to be displayed at a position on the side of a place to which the own vehicle is going, away from the own vehicle, in the own lane in the state of being disposed in parallel with a portion on the branch guidance lane in the graphic route display G12.

During high-speed autonomous driving, as in the case of FIG. 11, the driver is not required to perform any special operation so long as the operation follows the currently set scheduled traveling route and driving autonomy level. However, it is possible to arbitrarily switch over to manual driving as soon as the driver prepares for a driving switch. Therefore, as illustrated in FIG. 17, the presentation control unit 245 causes the first operation button display G21 with a text display of “SWITCH OVER TO MANUAL DRIVING” to be displayed in the fifth display area D5. The display intention of the first operation button display G21 in this case is similar to that in the case of FIG. 11. Therefore, the usage restriction of the second task during a wait for the input operation corresponding to the first operation button display G21, is not performed.

During hands-off driving, as in the example of FIG. 12, the driver's approval may be required for a lane change from the own lane in the main lane road to the branch guidance lane. Therefore, as illustrated in FIG. 18, the presentation control unit 245 causes the first operation button display G21 with a text display of “NOT LC” and a second operation button display G22 with a text display of “APPROVE LEFTWARD LC” to be displayed in the fifth display area D5. LC stands for lane change.

(5) Own Lane=Traffic Congestion/Lane Change Possible/Lane Change Destination=Non-Traffic Congestion

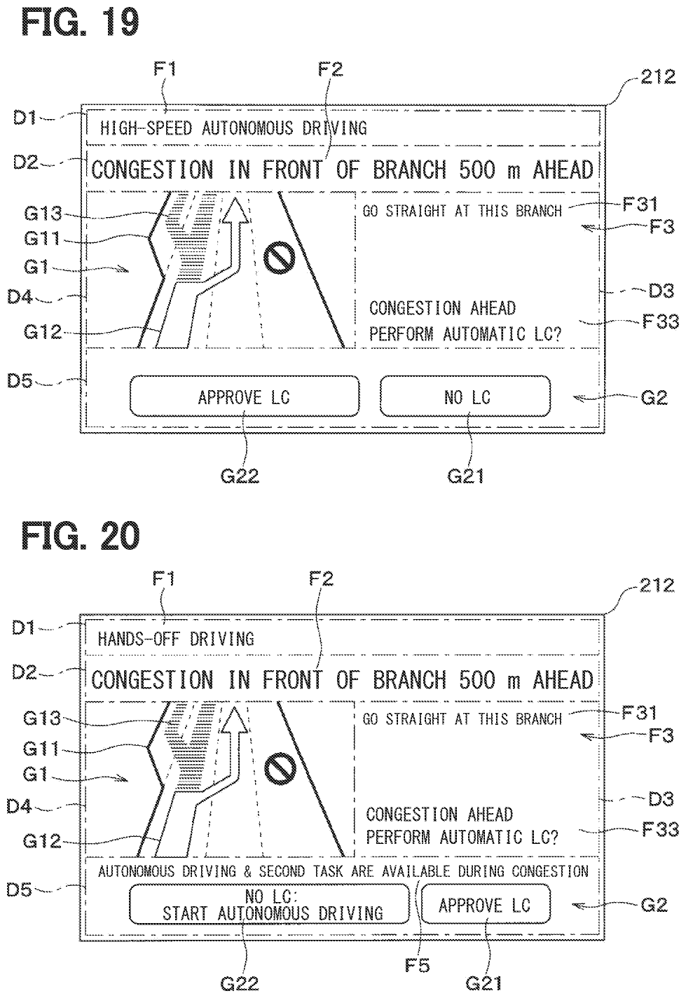

FIGS. 19 and 20 illustrate an example in which a place to which the own vehicle is going in the own lane is congested, the lane change is possible, and the other lane on the main lane road that is the lane change destination is not congested. FIG. 19 illustrates a case during high-speed autonomous driving, and FIG. 20 illustrates a case during hands-off driving.

Specifically, in this example, traffic congestion has occurred in the branch guidance lane and in a place to which the own vehicle is going in the own lane, and an overtaking lane on the rightmost side, that is, the median strip side, of the main lane road having three lanes on each side is regulated due to construction. Due to the occurrence of traffic congestion in the branch guidance lane and the lane restriction due to construction, traffic congestion has occurred only in the own lane on the main lane road. On the other hand, in the second traveling lane adjacent to the own lane, although no traffic congestion has occurred within a predetermined distance range (e.g., within 3 km) from the own vehicle at present, traffic congestion may occur in the future.

In this example, when the own vehicle changes lanes to the second traveling lane adjacent to the own lane, the own vehicle may be caught in traffic congestion in the future, but it is possible to avoid the traffic congestion at least temporarily. Therefore, the presentation control unit 245 presents lane change information and course congestion information.

Specifically, as illustrated in FIGS. 19 and 20, the presentation control unit 245 causes the attention information display F33 of “CONGESTION AHEAD/MAKE AUTOMATIC LC?” to be displayed in the third display area D3. The presentation control unit 245 performs the following display on the graphic lane display G11 in the fourth display area D4.

That is, the presentation control unit 245 sets a portion on the near side in the graphic route display G12 on the own lane as the normal display. On the other hand, the presentation control unit 245 sets a portion on the side closer to a place to which the own vehicle is going than the normal display portion in the graphic route display G12 on the own lane as the warning display and causes the portion to be displayed as the graphic traffic information display G13 indicating the congestion section. The presentation control unit 245 causes the graphic traffic information display G13 indicating the congestion section to be displayed so as to branch off the graphic traffic information display G13 indicating the congestion section in the own lane toward the branch guidance lane.

Furthermore, the presentation control unit 245 causes an arrow-like figure, extending right-forward from the proceeding-direction side end of the normal display portion on the near side in the graphic route display G12 on the own lane, to be displayed as the normal display as an additional graphic route display G12 indicating the lane change possibility. In addition, the presentation control unit 245 causes the graphic traffic information display G13 having a figure similar to that of a traffic sign for vehicle traffic closure to be displayed at a position corresponding to an overtaking lane in which traffic is restricted.

There may be an option of keeping the own lane where traffic congestion has occurred ahead without intentionally avoiding the traffic congestion by a lane change depending on the preference or circumstances of the occupant of the own vehicle such as the driver. For example, there may be a case where the arrival time at the destination is unnecessarily too early when the traffic congestion is avoided because the road condition on the already traveled route is unexpectedly good. In this case, the arrival time may be adjusted by the congestion traveling.

Therefore, during high-speed autonomous driving, the presentation control unit 245 causes the first operation button display G21 with a text display of “NOT LC” and the second operation button display G22 with a text display of “APPROVE LC” to be displayed in the fifth display area D5. In this case, attention information display F33 corresponds to input request presentation. During a wait for the input operation corresponding to the operation button display G2, the use of the second task is restricted.

In the example of the hands-off driving illustrated in FIG. 20, the driver can perform, as the autonomous steering control, the autonomous driving control in which the driver can use the second task in the HMI device 20 on a condition that the own vehicle is traveling in traffic congestion. That is, when a lane change is made to avoid the traffic congestion, the start condition for the congestion autonomous driving is not satisfied. On the other hand, when the own lane in which traffic congestion has occurred ahead is kept without intentionally avoiding the traffic congestion by a lane change, the start condition for the congestion autonomous driving is satisfied, and the second task can also be used.

Therefore, during hands-off driving, the presentation control unit 245 performs input request presentation for prompting an input operation for selecting whether to change lanes and approve non-execution of autonomous driving due to the condition being not satisfied or to keep the own lane and approve the execution of autonomous driving and the use of the second task. Specifically, the presentation control unit 245 causes the guidance information display F5 of “AUTONOMOUS DRIVING & SECOND TASK ARE AVAILABLE DURING CONGESTION” to be displayed in the fifth display area D5. The presentation control unit 245 does not cause the first operation button display G21 with a text display of “APPROVE LC” and the second operation button display G22 with a text display of “NOT LC: START AUTONOMOUS DRIVING” to be displayed in the fifth display area D5.

(6) Own Lane=Traffic Congestion/Lane Change Required/Lane Change Destination=Traffic Congestion

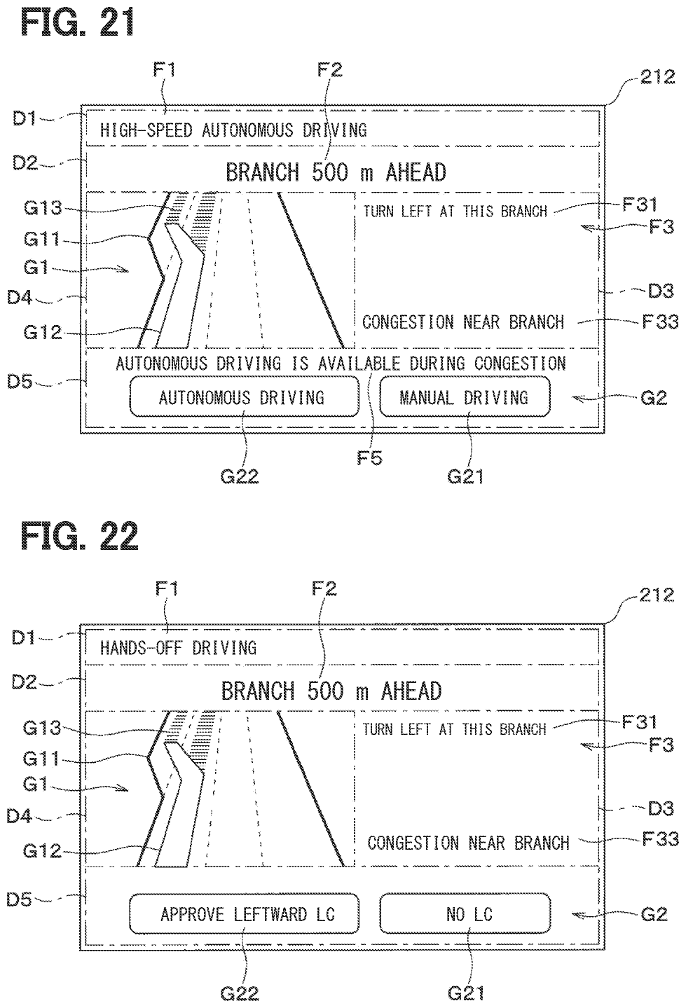

FIGS. 21 and 22 illustrate an example in which a place to which the own vehicle is going in the own lane is congested, a lane change to the branch guidance lane side is necessary according to the scheduled traveling route, and the branch guidance lane as the lane change destination is also congested. FIG. 21 illustrates a case during high-speed autonomous driving, and FIG. 22 illustrates a case during hands-off driving. In this example, the display contents of the short-distance information display F2 and the proceeding-direction display F31 are similar to those in FIGS. 11 and 12.

In this example, it is easier to change lanes during traveling in a high-speed range than during congestion traveling. It is thus desirable that the own vehicle change lanes to the branch guidance lane side before reaching the end of the congestion line, the congestion end of which is nearer between the congestion line in the own lane and the congestion line in the branch guidance lane. Therefore, the presentation control unit 245 presents lane change information and course congestion information.

Specifically, as illustrated in FIGS. 21 and 22, the presentation control unit 245 causes the attention information display F33 of “CONGESTED NEAR BRANCH” to be displayed in the third display area D3. The presentation control unit 245 performs the following display on the graphic lane display G11 in the fourth display area D4. That is, the presentation control unit 245 causes the graphic traffic information display G13 indicating the congestion section to be displayed in the branch guidance lane. Further, the presentation control unit 245 causes the graphic route display G12, changing lanes from the own lane and reaching the end of the traffic congestion in the branch guidance lane, to be displayed as the normal display. Moreover, the presentation control unit 245 causes the graphic traffic information display G13 indicating the congestion section to be displayed at a position on the side of a place to which the own vehicle is going, away from the own vehicle, in the own lane.

During high-speed autonomous driving, as in the example of FIG. 15, the presentation control unit 245 causes the guidance information display F5 of “AUTONOMOUS DRIVING IS ALSO AVAILABLE DURING CONGESTION” to be displayed in the fifth display area D5, as illustrated in FIG. 21. The presentation control unit 245 does not cause the first operation button display G21 with a text display of “MANUAL DRIVING” and the second operation button display G22 with a text display of “AUTONOMOUS DRIVING” to be displayed in the fifth display area D5.

During hands-off driving, as in the example of FIG. 18, the driver's approval may be required for a lane change from the own lane in the main lane road to the branch guidance lane. Therefore, as illustrated in FIG. 22, the presentation control unit 245 causes the first operation button display G21 with a text display of “NOT LC” and a second operation button display G22 with a text display of “APPROVE LEFTWARD LC” to be displayed in the fifth display area D5.

### Overall Embodiment

As described in each of the above embodiments, according to the present disclosure, the HMI control device 24 includes the control status acquisition unit 242, the traveling environment acquisition unit 243, the entry status acquisition unit 244, and the presentation control unit 245. The control status acquisition unit 242 acquires the execution status of the autonomous steering control. The traveling environment acquisition unit 243 acquires the traveling environment of the own vehicle including congestion information. The entry status acquisition unit 244 acquires the status of entry of the own vehicle into a congestion section included in the congestion information. The presentation control unit 245 presents, by the HMI device 20, the congestion information corresponding to the congestion section and lane information related to the possibility of a lane change in the own vehicle when the acquired execution status of the autonomous steering control is that the autonomous steering control is being executed and the acquired entry status is that the own vehicle enters the congestion section.

Further, according to the present disclosure, an HMI control method is a method for controlling HMI device 20, the HMI control method including:

acquiring an execution status of the autonomous steering control;

acquiring a traveling environment of the own vehicle including congestion information;

acquiring a status of entry of the own vehicle into a congestion section included in the congestion information; and

presenting, by the HMI device 20, the congestion information corresponding to the congestion section and lane information related to a possibility of a lane change in the own vehicle when the acquired execution status of the autonomous steering control is that the autonomous steering control is being executed in the own vehicle and the acquired entry status is that the own vehicle enters the congestion section included in the acquired congestion information.

Further, according to the present disclosure, the HMI control program is a program executed by the HMI control device 24 configured to control the HMI device 20, wherein

processing executed by the HMI control device 24 includes

acquiring an execution status of the autonomous steering control,

acquiring a traveling environment of the own vehicle including congestion information,

acquiring a status of entry of the own vehicle into a congestion section included in the congestion information, and

presenting, by the HMI device 20, the congestion information corresponding to the congestion section and lane information related to a possibility of a lane change in the own vehicle when the acquired execution status of the autonomous steering control is that the autonomous steering control is being executed in the own vehicle and the acquired entry status is that the own vehicle enters the congestion section included in the acquired congestion information.

According to the configuration, the method, and the program as thus described, the congestion information and the lane information are presented to the occupant of the own vehicle such as the driver by the HMI device 20 when the own vehicle enters the congestion section. As a result, the occupant of the own vehicle such as the driver can easily understand or grasp the cause or reason of the vehicle driving control behavior in the own vehicle during autonomous steering control when the own vehicle enters the congestion section.

### Modifications

The present disclosure is not limited to the above embodiments. Hence the above embodiments can be changed appropriately. Hereinafter, representative modifications will be described. In the following description of modifications, differences from the above embodiments will be mainly described. In the above embodiments and the modifications, the same or equivalent portions are denoted by the same reference numerals. Therefore, in the following description of the modifications, with respect to constituent elements having the same reference numerals as those in the embodiments, the description in the above embodiments can be appropriately incorporated unless there is a technical contradiction or a special additional description.

The present disclosure is not limited to the specific device configuration described in the above embodiments. That is, for example, the vehicle mounted with the in-vehicle system 10 is not limited to a four-wheeled vehicle. Specifically, such a vehicle may be a three-wheeled automobile or may be a six-wheeled or eight-wheeled automobile such as a cargo truck. The type of the vehicle may be a conventional vehicle including only an internal combustion engine, an electric vehicle or a fuel cell vehicle not including an internal combustion engine, or a so-called hybrid vehicle. The shape and structure of the vehicle body in the vehicle are not limited to a box shape, that is, a substantially rectangular shape in a plan view. The application of the vehicle, the position of the steering wheel 191, the number of occupants, and the like are not particularly limited.

As a communication standard constituting the in-vehicle system 10, it is also possible to adopt a communication standard except for Controller Area Network (CAN) (international registered trademark), for example, FlexRay (international registered trademark) or the like. The communication standard constituting the in-vehicle system 10 is not limited to one type. For example, the in-vehicle system 10 may have a subnetwork line conforming to a communication standard such as LIN. LIN stands for Local Interconnect Network.

The vehicle state sensor 11, the external state sensor 12, and the surrounding monitoring sensor 13 are also not limited to the above examples. For example, the surrounding monitoring sensor 13 may include sonar, that is, an ultrasonic sensor. Alternatively, the surrounding monitoring sensor 13 may include two or more types of millimeter-wave radar sensor, a sub-millimeter-wave radar sensor, a laser radar sensor, and an ultrasonic sensor. The number of various sensors installed is not particularly limited.

The locator 14 is also not limited to the above examples. For example, the locator 14 may not have the configuration incorporating the gyro sensor and the acceleration sensor. Specifically, the inertial acquisition unit 142 may receive output signals from an angular velocity sensor and an acceleration sensor provided outside the locator 14 as the vehicle state sensor 11.

The DCM 15 can be omitted. That is, the traffic information can be obtained by the navigation device 16. Alternatively, the navigation device 16 may have a configuration including the locator 14 and the DCM 15.

The navigation device 16 may be connected to the HMI control device 24 so as to be able to perform information communication via a sub-communication line different from the in-vehicle communication line 10A.

The navigation device 16 may have a display screen exclusive to navigation screen display different from the HMI device 20. Alternatively, the navigation device 16 may be provided as a part of the HMI device 20. Specifically, for example, the navigation device 16 may be integrated with the CID device 22.

In the above embodiments, the driving control ECU 17 has been configured to be able to execute both the high-speed autonomous driving in which traveling in a high-speed range is possible in a specific section and the congestion autonomous driving in which traveling in a medium-to-low speed range is possible during traffic congestion. However, the present disclosure is not limited to such an aspect. That is, for example, the driving control ECU 17 may be capable of executing only the high-speed autonomous driving. Alternatively, the driving control ECU 17 may be capable of executing only the congestion autonomous driving.

Alternatively, the driving control ECU 17 may be capable of executing autonomous driving of a type different from the high-speed autonomous driving and the congestion autonomous driving described above. Specifically, for example, the driving control ECU 17 may be configured to be able to execute autonomous driving corresponding to SAE Level 3 under a condition of traveling in a predetermined low-speed range (e.g., 60 km/h or less) in a specific section. Such autonomous driving may be referred to as “low-speed autonomous driving”. Such low-speed autonomous driving can be executed during traffic congestion as well. The “traffic congestion” refers to a state where a line of vehicles repeating the low-speed traveling or the stopping and starting at a speed equal to or lower than a threshold speed continues to a predetermined extent, on the basis of the definitions of East Nippon Expressway Company Limited and Metropolitan Police Department. The threshold speed is, for example, 20 km/h on ordinary roads and main roads, and 40 km/h on highways. The “predetermined degree” is, for example, 1 km or more and 15 minutes or more.

The congestion autonomous driving may be executed only on an expressway regardless of whether or not the specific section is set. Alternatively, the congestion autonomous driving may be executed only in a specific section.

In the above embodiments, the driving control ECU 17 is configured to be able to perform a vehicle control operation corresponding to SAE Levels 1 to 3. Specifically, the driving control ECU 17 can alternatively execute any one of the hands-off driving at SAE Level 2, the high-speed autonomous driving at SAE Level 3, and the congestion autonomous driving at SAE Level 3 as the driving autonomy level of SAE Level 2 or higher. However, the present disclosure is not limited to such an aspect. That is, for example, the present disclosure can be suitably applied to a case where a vehicle control operation corresponding to each of SAE Levels 1 to 5 can be performed. Further, the level or category of driving automation in the present disclosure is not limited to those defined in “SAE J3016”.

Specifically, the “autonomous driving” in the above embodiments are a driving autonomy level corresponding to Levels 3 to 5 in “SAE J3016” at which the driving automation system is in charge of, that is, executes, all the dynamic driving tasks. Hence the definition of the “autonomous driving” in the above embodiments naturally includes that no monitoring obligation is imposed on the driver. The “monitoring obligation” refers to an obligation of a driver to monitor a traffic condition including a current traffic environment around the own vehicle.

However, the present disclosure is not limited to such an aspect. That is, for example, depending on the definition content of the “autonomous driving”, not only “autonomous driving with no monitoring obligation” but also “autonomous driving with monitoring obligation” can be conceptualized. Specifically, for example, the hands-off driving in the above embodiments can be interpreted as “autonomous driving in which monitoring is obliged”. The “autonomous driving” in this case is a concept including so-called “partial autonomous driving” in which the driver is in charge of, that is, executes, some dynamic driving tasks such as the monitoring obligation. The “partial autonomous driving” can be evaluated as being substantially synonymous with “advanced driving assistance”.

As described above, in the road traffic system of each country, the type and conditions of the autonomous driving (e.g., executable road, traveling-speed range, lane change propriety, etc.) can be appropriately considered corresponding to the domestic situation and the like. Thus, the present disclosure can be implemented in a specification adapted to the road traffic system of each country.

The DSM 18 may be connected to the HMI control device 24 so as to be able to perform information communication via a sub-communication line different from the in-vehicle communication line 10A.

The DSM 18 is not limited to the configuration in which the line of sight or the face direction of the driver is detected by image recognition. That is, for example, the DSM 18 may have a configuration in which the seating posture and the steering wheel holding state of the driver are detected by a sensor different from the image sensor.

The operation unit 19 may include a voice input device that detects the utterance of the driver.

The operation unit 19 may be provided as a part of the HMI device 20. That is, for example, an operation device (e.g., joystick, etc.) for steering control can be provided in the HMI device 20 instead of or in addition to the steering wheel 191.

The HMI device 20 is not limited to the configuration including the meter panel 21, the CID device 22, and the HUD device 23. That is, for example, the HMI device 20 may not include the CID device 22. In this case, the “CID device 22” and the “CID display 221” in the above embodiments can be replaced with the “HUD device 23”. The display mode including the display positions of the first display area D1 to the fifth display area D5 can also be adjusted appropriately. Specifically, the graphic road display G1 can be superimposed and displayed on the road surface in a place to which the own vehicle is going. On the other hand, other displays can be displayed at positions that do not interfere with the graphic road display G1. The function and configuration of the HUD device 23 are also not particularly limited. Alternatively, for example, the HMI device 20 may not include the HUD device 23. That is, the HMI device 20 may include the meter panel 21 and the CID device 22.

The meter 211 and the meter display 212 can be achieved by one display device. In this case, the meter 211 can be provided as display areas at both right and left terminates of one display device that is a liquid crystal or organic EL display. That is, the meter 211 can be achieved by displaying, as images, a bezel, a pointer, a scale, and the like corresponding to a tachometer, a speedometer, a water temperature gauge, and the like. The meter display 212 can be provided as a display area except for the meter 211 in such a display device.

The input device 222 may include a pointing device or the like operated by the driver's hand instead of or in addition to the touch panel superimposed on the CID display 221. The input device 222 may include a voice input device that detects the utterance of the driver.

In the above embodiments, the driving control ECU 17 and the HMI control device 24 have had a configuration as a so-called in-vehicle microcomputer including a CPU and the like. However, the present disclosure is not limited thereto.

For example, all or a part of the driving control ECU 17 may include a digital circuit configured to be able to perform the operation as described above, for example, an ASIC or an FPGA. ASIC stands for application specific integrated circuit. FPGA stands for field-programmable gate array. That is, in the driving control ECU 17, the in-vehicle microcomputer portion and the digital circuit portion can coexist. The same applies to the HMI control device 24.

The program according to the present disclosure capable of performing various operations, procedures, or processing described in the above embodiments can be downloaded or upgraded via V2X communication by the DCM 15 or the like. V2X stands for Vehicle to X. Alternatively, such a program can be downloaded or upgraded via a terminal device provided in a vehicle manufacturing factory, a maintenance factory, a sales shop, or the like. The storage destination of such a program may be a memory card, an optical disk, a magnetic disk, or the like.

The above-described functional blocks and method according to the present disclosure may be implemented by one or more special-purposed computers. Such a special-purposed computer may be provided (i) by configuring (a) a processor and a memory programmed to execute one or more functions embodied by a computer program, Alternatively, the functional blocks and method described in the present disclosure may be implemented by a special purpose computer including a processor with one or more dedicated hardware logic circuits. Alternatively, the functional blocks and method described in the present disclosure may be implemented by a combination of (a) a processor and a memory programmed to execute one or more functions embodied by a computer program and (b) a processor including one or more dedicated hardware logic circuits. The computer program may be stored in a computer-readable non-transitory tangible storage medium as an instruction to be executed by the computer. That is, each of the above functional blocks and method can be implemented as a computer program including instructions for performing the above process, or can be implemented as a non-transitory tangible storage medium in which the computer program is stored.

The present disclosure is not limited to the specific functional configurations and operation examples described in the above embodiments. For example, all or part of the various information displays illustrated in FIG. 2 and the like may be executed by another HMI device instead of or together with the meter display 212. The “other HMI device” is, for example, the CID device 22 and/or the HUD device 23.

The input operation, the reception of which is awaited, may be an override operation by the driver. The override operation is an intervention operation by the driver during autonomous driving control for shifting the driving of the own vehicle to manual driving. The override operation includes, for example, a manual operation of the steering wheel 191 or the like by the driver so as to set the steering speed, the steering angle, or the steering torque to a predetermined threshold or more. The override operation includes, for example, an artificial operation by the driver to set the depression amount or depression speed of the accelerator pedal to a predetermined threshold or more. The override operation includes, for example, an artificial operation by the driver to set the depression amount or the depression speed of the brake pedal to a predetermined threshold or more.

In the example of FIG. 3, the message “WILL YOU AVOID CONGESTION?” may be displayed in the fifth display area D5 as the guidance information display F5. The operation button display G2 for approving the lane change from the own lane to the right side may be displayed on the right side of the operation button display G2 for approving the maintenance of the own lane. That is, in FIG. 3, the positional relationship between the first operation button display G21 and the second operation button display G22 can be reversed right and left. Alternatively, the first operation button display G21 with a text display of “APPROVE AVOIDING CONGESTION” and the second operation button display G22 with a text display of “FOLLOW CONGESTION” can be displayed. As a result, the positional relationship between the first operation button display G21 and the second operation button display G22 coincides with the scheduled behavior of the own vehicle associated with the operation results of these displays. Hence the visibility and operability of the operation button display G2 are improved.

In the example of FIG. 4, the display in the fifth display area D5 may be similar to that in FIG. 2. Also, in the example of FIG. 7, as in the case of the example of FIG. 3, the operation button display G2 for approving the lane change from the own lane to the right side may be displayed on the right side of the operation button display G2 for approving the maintenance of the own lane. This improves the visibility and operability of the operation button display G2. The same applies to the examples of FIGS. 9 and 19. In FIG. 13, the first operation button display G21 may be “AVOID CONGESTION” similar to that in FIG. 14. In the examples of FIGS. 19 and 20, the display of “LC” in each of the first operation button display G21 and the second operation button display G22 may be a display of “AVOIDING CONGESTION”. In addition, the specific examples corresponding to FIGS. 2 to 5 and FIGS. 7 to 22 can be modified appropriately.

### Additional Embodiments

Hereinafter, an additional embodiment will be described. This additional embodiment corresponds to a road traffic system in which only “low-speed autonomous driving” on an “autonomous driving possible road” is possible as autonomous driving, and only lane keeping, that is, prevention of deviation from the own lane, is possible during such low-speed autonomous driving. The “autonomous driving possible road” is an expressway having a legal maximum speed exceeding 60 km/h and typically includes a highway. Such a road traffic system is a road traffic system that has been implemented in Japan since Apr. 1, 2020 and will be hereinafter abbreviated as “JP2020 Laws”.

### First Additional Embodiment

In a case where the above embodiments are modified to conform to JP2020 Laws, the “high-speed autonomous driving” and the “congestion autonomous driving” in the above embodiments can be replaced with “low-speed autonomous driving” or simply “autonomous driving”. In this case, the autonomous driving can be started, for example, when the own vehicle travels “optionally” at a speed equal to or lower than the upper speed limit of the autonomous driving in the traveling lane on the autonomous driving possible road. “Optionally” mean that the own vehicle travels in a low-speed range not caused by its entry into a congestion section or a low-speed traveling section but by the driver's selection even in a traffic condition where traveling in a high-speed range is possible. More specifically, for example, during hands-off driving at a set speed equal to or lower than the upper speed limit of the autonomous driving, it is possible to execute the autonomous driving while taking over the set speed. Alternatively, for example, the autonomous driving can be started when the own vehicle enters a congestion section or an equivalent low-speed traveling section on the autonomous driving possible road. According to this example, the traveling environment acquisition unit 243 illustrated in FIG. 1 acquires the traveling environment of the own vehicle including traffic information (i.e., the occurrence information of the congestion section or the low-speed traveling section). The entry status acquisition unit 244 acquires the status of entry of the own vehicle into the congestion section or the low-speed traveling section. When the autonomous steering control (e.g., autonomous driving) is being performed, the presentation control unit 245 presents, by the HMI device 20, the acquired traffic information and lane information related to the possibility of a lane change in the own vehicle.

However, the mode of modification is different between the example during autonomous driving (e.g., FIG. 2, etc.) and the example during hands-off driving (e.g., FIG. 9, etc.). That is, for example, even under JP2020 Laws, it is possible to perform automatic lane change control by the system during hands-off driving. Thus, in the example during hands-off driving, even when a modification involves a lane change, the modification conforms to JP2020 Laws almost as it is (e.g., FIG. 9, etc.). On the other hand, under JP2020 Laws, a lane change cannot be made during autonomous driving. Thus, for the example during autonomous driving, whether or not the lane change is involved is considered at the time of modification.

For example, as in the examples of FIGS. 2 and 15, an example without a lane change becomes an example conforming to JP2020 Laws by simply replacing “high-speed autonomous driving” with “autonomous driving”. In this case, even when the own vehicle approaches or enters the congestion section, the currently executed autonomous driving and the second task associated with the autonomous driving can be continued. Hence the guidance information display F5 and the operation button display G2 illustrated in FIGS. 2 and 15 can be omitted. However, the guidance information display F5 and the operation button display G2 may be displayed as illustrated in FIGS. 2 and 15 since the vehicle speed of the own vehicle decreases due to the approach to and the entry into the congestion section. However, even in a case where the guidance information display F5 and the operation button display G2 as thus described are displayed, the second operation button display G22 for selecting the continuation of the autonomous driving can be omitted.

In contrast, as illustrated in FIG. 3 and the like, in an example in which the own vehicle is currently in autonomous driving and there is a possibility of performing a lane change, when a lane change is performed, it is necessary to notify that the autonomous driving is interrupted or terminated and implement a driving switch before the lane change. When the advanced driving assistance at SAE Level 2 can be used after the lane change, a notification to that effect can also be performed. In such a case, when the autonomous driving is interrupted or terminated, processing for interrupting or terminating the use of the second task is also required. Specifically, for example, the display content of the CID display 221 is changed from the second task screen to a screen displaying a driving-related information display (e.g., map display, navigation display, etc.).

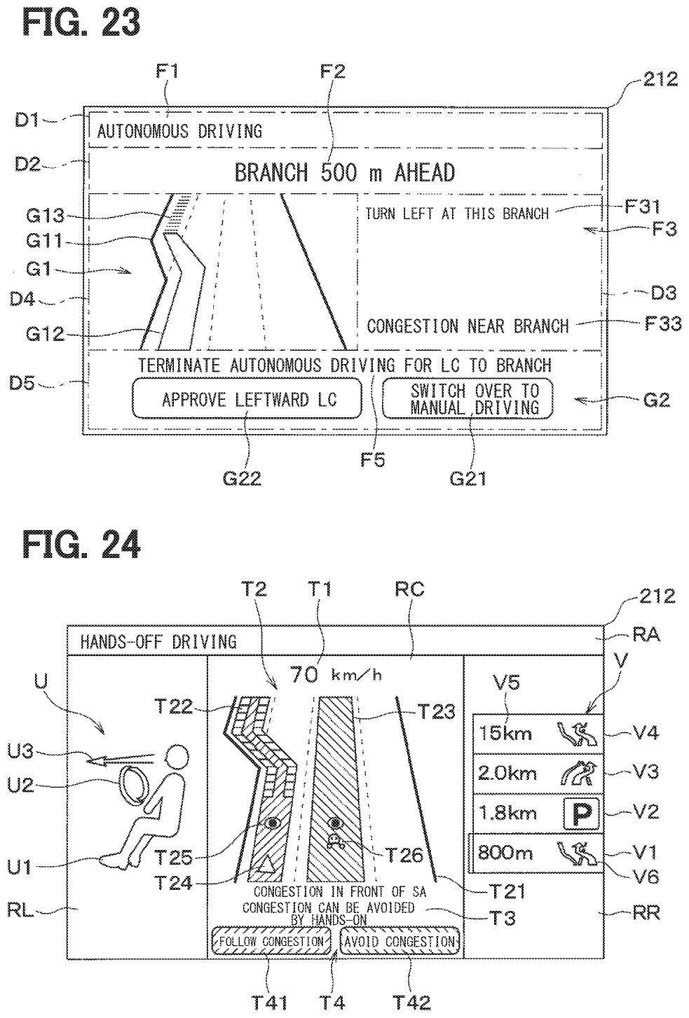

FIG. 23 illustrates an example in which the own lane is not congested during autonomous driving, a lane change to the branch guidance lane side is necessary according to the scheduled traveling route, and the branch guidance lane that is the lane change destination is congested, similarly to the example of FIG. 13. In the present example, the autonomous driving is possible in the congestion section at the branch end as a place to which the own vehicle is going on the scheduled traveling route. However, in order to perform a lane change to the branch end, it is necessary to suspend, that is, temporarily terminate, the autonomous driving.

Therefore, in the present example, the presentation control unit 245 causes the guidance information display F5 to be displayed in the fifth display area D5, the guidance information display F5 indicating that the autonomous driving will be terminated due to the lane change to the branch guidance lane side. The presentation control unit 245 causes the first operation button display G21 with a text display of “SWITCH OVER TO MANUAL DRIVING” and a second operation button display G22 with a text display of “APPROVE LEFTWARD LC” to be displayed in the fifth display area D5.

When an input operation is performed on the first operation button display G21 for approving the shift to the manual driving, the driving control ECU 17 and the HMI control device 24 each perform an operation necessary for the driving switch for shifting from the autonomous driving to the manual driving. Specifically, for example, the presentation control unit 245 performs information presentation processing for calling the driver's attention so as to take a driving posture to the degree that the accelerator pedal and the brake pedal can be operated at any time.

On the other hand, when the input operation is performed on the second operation button display G22 for approving the lane change to the branch guidance lane side, the driving control ECU 17 and the HMI control device 24 each perform an operation necessary for the driving switch for shifting from the autonomous driving to the hands-off driving. Specifically, for example, the presentation control unit 245 performs information presentation processing for calling attention to a traffic status including the current traffic environment around the own vehicle. When the lane change to the branch guidance lane is completed by the shift from the autonomous driving to the hands-off driving, and the own vehicle is traveling in the congestion section in the hands-off driving, the autonomous driving can be resumed by the driver's approval operation.

Thus, the display of the second operation button display G22 for approving the lane change can be evaluated as a display for presenting to the driver that the shift from the autonomous driving to the hands-off driving is possible. Further, displaying the first operation button display G21 for approving the shift to the manual driving and the second operation button display G22 for presenting to the driver that the hands-off driving is executable in the fifth display area D5 can be evaluated as the termination notification of the autonomous driving. Therefore, in the present example, it is possible to omit the guidance information display F5 indicating that the autonomous driving is terminated by the lane change to the branch guidance lane side.

### Second Additional Embodiment

A further additional embodiment will be described below. In the present embodiment, the in-vehicle system 10, that is, the driving control ECU 17, is configured to be able to perform low-speed autonomous driving in a traveling lane (i.e., a lane except for an overtaking lane) on the autonomous driving possible road. In the following description, unless otherwise noted or added, the “low-speed autonomous driving” is simply abbreviated as “autonomous driving”.

Further, in the present embodiment, the in-vehicle system 10 is configured to be able to execute “hands-off driving” and “hands-on driving”. The “hands-on driving” is advanced driving assistance corresponding to SAE Level 2 that requests a hands-on state but performs vehicle control similar to that of the “hands-off driving”, that is, a vehicle motion control subtask in both the longitudinal and lateral directions. The “hands-on state” is a state where the driver can interfere with the steering of the own vehicle, that is, the vehicle motion control subtask in the lateral direction, and is typically a state where the driver grips the steering wheel 191.

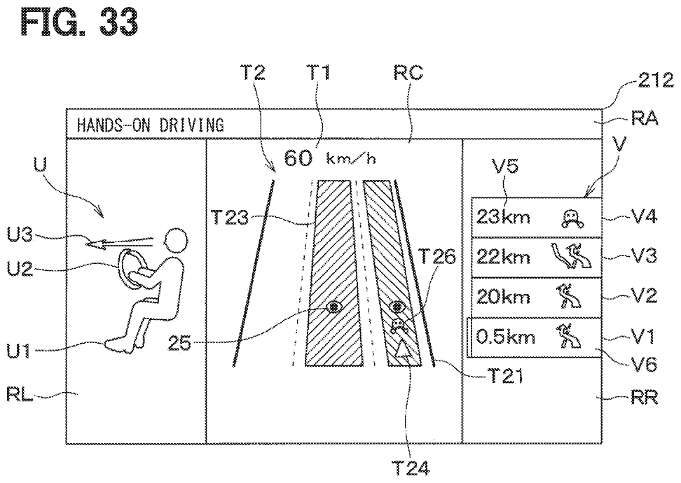

In the present embodiment, the meter display 212 has a screen display configuration different from that of the above embodiments. Specifically, referring to FIGS. 24 to 33, presentation control unit 245 causes various information to be displayed in each of an upper display area RA, a central display area RC, a left display area RL, and a right display area RR in the meter display 212.

The upper display area RA is an elongated band-shaped area extending in the lateral direction at the top of the display screen (hereinafter simply referred to as a “display screen”) of the meter display 212. The upper display area RA is provided over the entire width of the display screen. That is, the upper display area RA has an information presentation function similar to that of the first display area D1 (e.g., see FIG. 2) in the above embodiments.

The central display area RC, the left display area RL, and the right display area RR are disposed below the upper display area RA and adjacent to the upper display area RA. The central display area RC is provided at the center of the display screen in the lateral direction, that is, between the left display area RL and the right display area RR. The left display area RL is disposed on the left side of the central display area RC. The right display area RR is disposed on the right side of the central display area RC.

The central display area RC is an area for displaying a vehicle speed display T1, a graphic information display T2, a character information display T3, and an input button display T4. The vehicle speed display T1, the graphic information display T2, the character information display T3, and the input button display T4 are disposed in this order from top to bottom.

The vehicle speed display T1 is a display of the current vehicle speed of the own vehicle. The graphic information display T2 includes a graphic display indicating traffic information and lane information related to the possibility of a lane change in the own vehicle. That is, the graphic information display T2 has an information presentation function similar to that of the graphic road display G1 (e.g., see FIG. 2) in the above embodiments. Specifically, the graphic information display T2 can display a lane division line display T21, congestion display T22, an autonomy level display T23, an own vehicle icon T24, a monitoring obligation icon T25, a hands-on icon T26, and an autonomous driving icon T27.

The lane division line display T21 is a graphic display indicating the lane arrangement and the branch structure in the road width direction within a predetermined short-distance range from the own vehicle, which is a place to which the own vehicle is going on the road on which the own vehicle is currently traveling. That is, the lane division line display T21 has an information presentation function similar to that of the graphic lane display G11 (e.g., see FIG. 2) in the above embodiments. The lane division line display T21 is drawn in a diagonal line shape so as to be closer to the center position in the width direction of the central display area RC from the lower side toward the upper side in the figure. That is, the interval between the lane division line displays T21 adjacent to each other decreases from the near side, which is the lower side of the screen, toward the far side, which is the upper side of the screen, that is, the side of the place to which the vehicle is going. In other words, the lane divided by the pair of lane division line displays T21 adjacent to each other is displayed with perspective such that the proceeding direction of the own vehicle is a direction from the lower side to the upper side of the display screen and the lane width becomes narrower as the distance from the own vehicle increases. The congestion display T22 to an autonomous driving icon T27 are displayed as necessary at positions corresponding to the respective lanes divided by the pair of lane division line displays T21.

The congestion display T22 is displayed at a position corresponding to the congestion section. That is, the congestion display T22 has an information presentation function similar to that of the graphic route display G12 of the warning display or the graphic traffic information display G13 corresponding to the lane during traffic congestion (e.g., see FIGS. 2, 3, etc.) in the above embodiments.

The autonomy level display T23 is a graphic display indicating a driving autonomy level corresponding to each lane. That is, the autonomy level display T23 is displayed in a display mode different among the hands-on driving, the hands-off driving, and the autonomous driving. Specifically, in the present example, the autonomy level display T23 is a band-shaped or thick-line-shaped graphic display extending in the lane along the extending direction of the lane. The distinction of the display mode among the hands-on driving, the hands-off driving, and the autonomous driving can be made by, for example, at least one of hue, saturation, brightness, transparency, and pattern, typically at least hue.

The monitoring obligation icon T25 is a graphic display indicating that the monitoring obligation is imposed on the driver. In the present example, the monitoring obligation icon T25 is configured by a figure representing “eye”.

The hands-on icon T26 is a graphic display indicating that the driver is required to be in the hands-on state. In the present example, the hands-on icon T26 includes a figure obtained by deforming a state where the driver grips the steering wheel 191.

The autonomous driving icon T27 is a graphic display indicating the autonomous driving. In the present example, the autonomous driving icon T27 is configured by a figure obtained by deforming a front view of an automobile.

The character information display T3 is a text display indicating various guidance information concerning the autonomous steering driving. That is, the character information display T3 has an information presentation function similar to that of the guidance information display F5 (e.g., see FIG. 2) in the above embodiments.

The input button display T4 is an operation button-like graphic display for receiving an input operation by the driver or the like. That is, the input button display T4 has a user interface function similar to that of the operation button display G2 (e.g., see FIG. 2) in the above embodiments. The input button display T4 is displayed in the lowermost portion of the central display area RC.

The input button display T4 typically includes a first input button display T41 and a second input button display T42 as illustrated in FIG. 24 and the like. The first input button display T41 is disposed on the left side of the second input button display T42. As illustrated in FIG. 30, a third input button display T43 is displayed above the first input button display T41 and the second input button display T42 as necessary.

The left display area RL is an area for displaying a driving condition display U. The driving condition display U is a display for visually presenting information to the driver about a driving operation state required for the driver (i.e., a state in charge of the dynamic driving task). The driving condition display U includes a driver icon U1, a steering icon U2, and a line-of-sight icon U3.

The driver icon U1 is an icon image imitating a driver being seated on a driver's seat. The steering icon U2 is an icon image imitating the steering wheel 191. The line-of-sight icon U3 is an arrow-shaped icon image extending from the head of the driver icon U1 and indicating that the monitoring obligation is imposed on the driver.

The right display area RR is an area for displaying a time chart V. The time chart V displays various events from the current position of the own vehicle to the arrival at the destination in time series. The “event” includes, for example, entry to an autonomous driving possible road, exit from an autonomous driving possible road, a branch, arrival at a destination, and the like.

Specifically, the time chart V includes a first segment V1, a second segment V2, a third segment V3, and a fourth segment V4. The first segment V1, the second segment V2, the third segment V3, and the fourth segment V4 are disposed in this order from the bottom to the top. The first segment V1 displays an event scheduled most recently. The first segment V1 is displayed so as to be more conspicuous than other segments, for example, as illustrated in FIG. 24, the left vertical ruled line is displayed with high luminance. The second segment V2 displays an event scheduled next to the event displayed in the first segment V1. The third segment V3 displays an event scheduled next to the event displayed in the second segment V2. The fourth segment V4 displays an event scheduled next to the event displayed in the third segment V3.

A distance display V5 and an event icon V6 are displayed in each of the first segment V1 to the fourth segment V4. The distance display V5 is a text display indicating a scheduled traveling distance from the current position of the own vehicle. The event icon V6 is an icon indicating the classification of the event. A segment in which the distance display V5 is displayed but the event icon V6 is not displayed indicates the arrival at the destination. On the other hand, when the event icon V6 is displayed but the distance display V5 is not displayed in the first segment V1, it is assumed that the event corresponding to the event icon V6 is the event at the present time.

### Additional Operation Example 1

Similarly to the example of FIG. 9, FIG. 24 illustrates an example in which during hands-off driving, traffic congestion has occurred in a branch guidance lane to a service area set to stop by on a scheduled traveling route, and the end of the traffic congestion has reached the own lane. Specifically, referring to FIG. 24, the present example illustrates an example of the scheduled traveling route as follows. The own vehicle changes lanes about 800 m ahead from the first traveling lane of three lanes on each side to the branch guidance lane on the left side, and stops at the service area. After leaving the service area, the own vehicle merges with a main lane road about 2 km ahead of the current point and proceeds to a branch road side at a junction about 15 km ahead. In the following additional operation example, various displays, that is, information display, on the meter display 212 as illustrated below and audio output corresponding to the information display are appropriately performed as necessary.

In the present example, as illustrated in FIG. 24, information indicating that the hands-off driving is currently performed is displayed in the upper display area RA. A time chart V corresponding to the scheduled traveling route as described above is displayed in the right display area RR. During hands-off driving, traveling in a high-speed range exceeding 60 km/h is possible within the speed limit range. Thus, FIG. 24 illustrates an example in which the own vehicle is traveling at 70 km/h as indicated by the vehicle speed display T1 in the central display area RC.

At present, there is a margin in distance or time until the own vehicle reaches the end of the traffic congestion. It is thus possible to select whether to stop by the service area scheduled to be stopped by as scheduled or cancel the stopover to the service area. In the case of stopping by the service area, after reaching the end of the traffic congestion and entering the congestion section, the own vehicle changes lanes to the branch guidance lane during congestion traveling. In contrast, in the case of canceling the stopover to the service area, the own vehicle can accept the congestion traveling and keep the first traveling lane or can change lanes to the second traveling lane on the right so as to overtake the congestion section in a place to which the own vehicle is going in the first traveling lane and avoid the traffic congestion.

During hands-off driving, a lane change can be made without interrupting or terminating the currently executed hands-off driving. However, in the case of changing lanes to the second traveling lane on the right, the driving autonomy level may be temporarily lowered from the current level in consideration of the possibility of unexpected behavior of other vehicles traveling in the second traveling lane and the overtaking lane. Therefore, the presentation control unit 245 presents information corresponding to a change destination lane to which lanes can be changed from the own lane.

Specifically, in the central display area RC, the autonomy level display T23 corresponding to the hands-off driving is displayed from the first traveling lane, which is the own lane where the own vehicle icon T24 exists, to the branch guidance lane. For the congestion section, such an autonomy level display T23 is displayed in the state of being superimposed on the congestion display T22. Therefore, in the present example, the autonomy level display T23 from the first traveling lane, which is the non-congestion section where the own vehicle is currently traveling, to the branch guidance lane during traffic congestion has an information presentation function similar to that of the graphic route display G12 (e.g., see FIG. 9) in the above embodiments. The monitoring obligation icon T25 is displayed at “a position on the near side” of the first traveling lane, that is, a position near the own vehicle icon T24 on the side closer to a place to which the own vehicle is going than the own vehicle icon T24. These displays indicate that, under hands-off driving, the lane change to the branch guidance lane can be automatically made while congestion traveling is performed.

On the other hand, the autonomy level display T23 corresponding to the hands-on driving is displayed from the near side to the far side in the second traveling lane adjacent to the own lane on the right side of the own lane. The monitoring obligation icon T25 and the hands-on icon T26 are each displayed at a position on the near side in the second traveling lane. These displays indicate that the performance of the monitoring obligation and the hands-on operation are required at the time of the lane change to the second traveling lane, and the hands-off driving is possible after the lane change. At present, the own vehicle is traveling in the first traveling lane. Hence the overtaking lane that is not adjacent to the first traveling lane, which is the own lane, is not a direct lane change destination from the own lane. Therefore, in the present example, the autonomy level display T23, the monitoring obligation icon T25, and the hands-on icon T26 are not displayed in the overtaking lane. Among the autonomy level display T23 to the autonomous driving icon T27, those except for the own vehicle icon T24 are hereinafter collectively referred to as “the autonomy level display T23 and the like”.

In the character information display T3, information indicating that traffic congestion has occurred in front of the service area and traffic congestion can be avoided by temporarily shifting to the hands-on driving is displayed. Moreover, as the input button display T4, the first input button display T41 indicating “FOLLOW CONGESTION” for selecting to proceed to the branch guidance lane toward the service area following the traffic congestion and the second input button display T42 for selecting to avoid the traffic congestion are displayed.

In the present embodiment, the display of the input button display T4 is associated with the display of the autonomy level display T23. In the example of FIG. 24, the first input button display T41 indicating “FOLLOW CONGESTION” is disposed on the left side as viewed from the front, similarly to the autonomy level display T23 from the first traveling lane to the branch guidance lane in which the own vehicle will travel when the first input button display T41 is selected. Such a first input button display T41 is displayed in a display mode corresponding to the hands-off driving, similar to the autonomy level display T23 from the first traveling lane to the branch guidance lane. Specifically, for example, when the autonomy level display T23 corresponding to the hands-off driving is displayed in a green band shape, the first input button display T41 is displayed in green in its outline and/or in its entirety.

Similarly, the second input button display T42 indicating “AVOID CONGESTION” is disposed on the right side as viewed from the front, similarly to the autonomy level display T23 displayed on the second traveling lane on the right side of the own lane at the present time, in which the own vehicle will travel when the second input button display T42 is selected. The second input button display T42 is displayed in a display mode corresponding to the hands-on driving similar to the autonomy level display T23 provided in the second traveling lane. Specifically, for example, when the autonomy level display T23 corresponding to the hands-on driving is displayed in a yellow band shape, the second input button display T42 is displayed in yellow in its outline and/or in its entirety.

During hands-off driving, the driver is not required to grip the steering wheel 191 but is obliged to perform monitoring. Thus, as illustrated in FIG. 24, in the left display area RL, the driver icon U1 is displayed in the “hands-off state” in which the hands are not placed on the steering icon U2. On the other hand, the line-of-sight icon U3 is set to a display state, that is, a lighting state.

For example, when the input operation is performed on the second input button display T42 for selecting to avoid traffic congestion in the display state illustrated in FIG. 24, the input button display T4 is deleted upon reception of the input operation. On the other hand, various information presentation for calling attention to surrounding monitoring is performed along with the shift to the hands-on state. Specifically, for example, the line-of-sight icon U3 is displayed in a blinking manner. The driver icon U1 is displayed in the “hands-on state” in which the hands are placed on the steering icon U2, and the hand portion is displayed in a blinking manner. Furthermore, in the character information display T3, a call attention display such as “PLEASE PAY ATTENTION TO FRONT AND SURROUNDINGS” or “PLEASE GRIP STEERING WHEEL” is made.

### Additional Operation Example 2

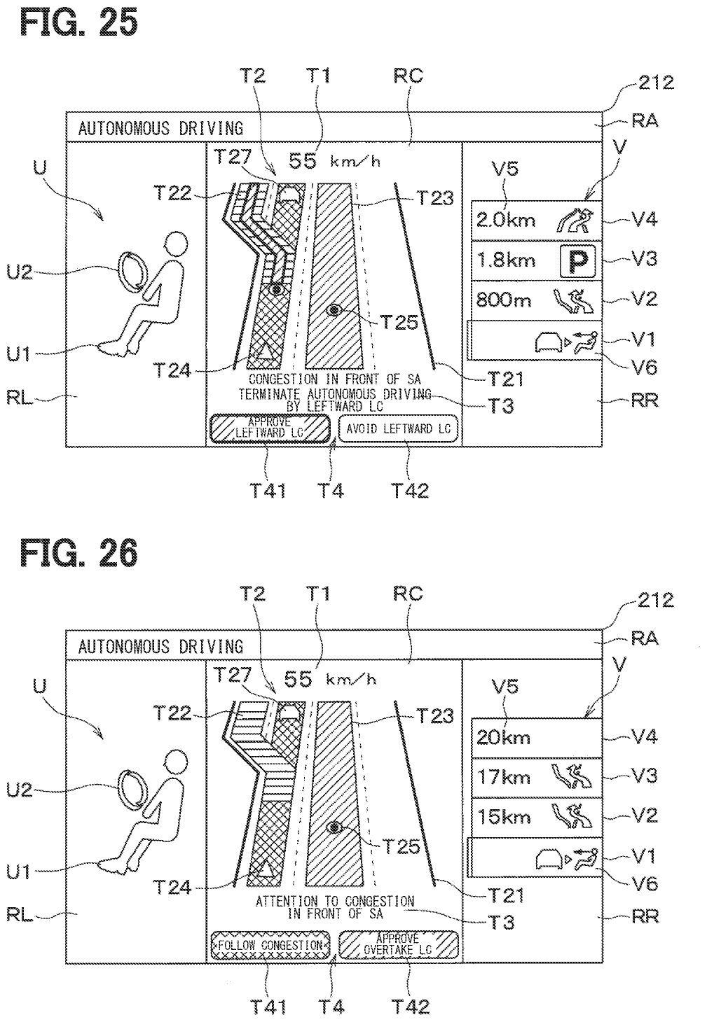

Similarly to the example of FIG. 7, FIG. 25 illustrates an example in which during autonomous driving, traffic congestion has occurred in a branch guidance lane to a service area set to stop by on a scheduled traveling route, and the end of the traffic congestion has reached the own lane. Specifically, the example of FIG. 25 is obtained by changing the example of FIG. 24 from the hands-off driving to the autonomous driving. During autonomous driving, the own vehicle can travel at 60 km/h or less. Therefore, FIG. 25 illustrates an example in which the own vehicle is traveling at 60 km/h or less as indicated by the own vehicle speed display T1 in the central display area RC.

In this case, as illustrated in FIG. 25, information indicating that the own vehicle is currently in autonomous driving is displayed in the upper display area RA. In the left display area RL, the driving condition display U is set to a display state corresponding to the autonomous driving. Specifically, the driver icon U1 is displayed in the “hands-off state” in which the hands are not placed on the steering icon U2. Moreover, the line-of-sight icon U3 is erased, that is, set to a non-display state.

In the present example, in the case of stopping by the service area in accordance with the scheduled traveling route, it is necessary to terminate the autonomous driving in order to change lanes to the branch guidance lane. On the other hand, in the case of avoiding the stopover to the service area, it is possible to continue the use of the second task while avoiding the interruption or the termination of the currently executed autonomous driving by accepting the temporary congestion traveling and keeping the first traveling lane where the own vehicle is currently traveling. However, in order to select to avoid the traffic congestion, that is, to overtake the congestion section, it is necessary to interrupt the currently executed autonomous driving and second task in order to enable a lane change necessary for overtaking. Considering these possibilities, it is necessary to call attention concerning the driving switch from the autonomous driving to the hands-off driving at the present time.

Therefore, in the present example, the event icon V6 indicating the driving switch from the autonomous driving to the hands-off driving in the case of stopping by the service area in accordance with the scheduled traveling route is displayed in the first segment V1 in the time chart V. Since such a driving switch or the notification thereof is necessary at the present time, the distance display V5 is not displayed in the first segment V1.

In the central display area RC, the autonomy level display T23 corresponding to the currently executed autonomous driving is displayed in a portion on the nearer side than the congestion display T22 in the first traveling lane that is the own lane where the own vehicle icon T24 exists. On the other hand, the autonomy level display T23 corresponding to the hands-off driving is displayed from the end point of the autonomy level display T23 corresponding to the autonomous driving in the first traveling lane over the branch guidance lane in the state of being superimposed on the congestion display T22. These autonomy level displays T23 each have an information presentation function similar to that of the graphic route display G12 (e.g., see FIG. 7) in the above embodiments. Moreover, the autonomy level display T23 corresponding to the autonomous driving is displayed in a portion on the farther side, that is, the more proceeding-direction side, than the congestion display T22 in the first traveling lane. The autonomy level display T23 indicates that the autonomous driving can be continued by accepting the temporary congestion traveling and keeping the first traveling lane where the own vehicle is currently traveling.

On the other hand, the autonomy level display T23 corresponding to the hands-off driving is displayed from the near side to the far side in the second traveling lane adjacent to the own lane on the right side of the own lane. In the present example, each of the two autonomy level displays T23 corresponding to the hands-off driving is displayed in different display modes that are similar to each other but can be identified. Specifically, for example, when the autonomy level display T23 corresponding to the hands-off driving is displayed in a green belt shape, the outline of the other display superimposed on the congestion display T22 on the left side is displayed with higher luminance than the outline of the other display displayed on the second traveling lane. Further, the autonomy level display T23 and the like are not displayed in the overtaking lane that is not the adjacent lane of the own lane.

The character information display T3 displays information indicating that traffic congestion has occurred in front of the service area and that it is necessary to terminate the autonomous driving in order to change lanes to the branch guidance lane in the case of stopping by the service area along the scheduled traveling route. Moreover, as the input button display T4, the first input button display T41 for approving a lane change for proceeding to the branch guidance lane toward the service area following traffic congestion and the second input button display T42 for avoiding such a lane change are displayed. The display of the first input button display T41 for approving the lane change to the left direction and the following of the traffic congestion is associated with the display of the autonomy level display T23 superimposed on the congestion display T22.

A monitoring obligation icon T25 is displayed closer to a place to which the own vehicle is going than the own vehicle icon T24 and in the vicinity of the start point of the congestion display T22. The monitoring obligation icon T25 is also displayed at a position on the near side in the second traveling lane. Moreover, in the first traveling lane, the autonomous driving icon T27 is displayed at the front end, that is, at the far-side end, of the display of the autonomy level display T23 corresponding to the autonomous driving.

When the input operation is performed on the second input button display T42 disapproving a lane change to the left for proceeding to the branch guidance lane on the display screen illustrated in FIG. 25, the display screen is switched over to the display state illustrated in FIG. 26. At this time point, there is a possibility that the currently executed autonomous driving continues by keeping the traveling in the own lane. Thus, the upper display area RA and the driving condition display U are set to a display state corresponding to the autonomous driving. That is, the display state illustrated in FIG. 25 is kept for the upper display area RA and the driving condition display U.

In the time chart V, the event icon V6 corresponding to the stopover to the service area is deleted, and the stepped-up display of the subsequent event is performed. However, at this time point, there is a possibility that a lane change to the second traveling lane is performed in order to avoid traffic congestion. Thus, the display of the event icon V6 indicating the driving switch from the autonomous driving to the hands-off driving at this time point in the first segment V1 is kept from the display state illustrated in FIG. 25.

In the central display area RC, the autonomy level display T23 corresponding to the autonomous driving that can be continued by keeping the lane is displayed in the first traveling lane that is the own lane in which the own vehicle icon T24 exists. In the display screen illustrated in FIG. 25, the autonomy level display T23, corresponding to the hands-off driving displayed in the state of being superimposed on the congestion display T22, and the monitoring obligation icon T25 near the start point of the autonomy level display T23 are hidden in FIG. 26. The display state illustrated in FIG. 25 is kept for the second traveling lane and the overtaking lane.

In the character information display T3, information for calling attention to the occurrence of traffic congestion in front of the service area is displayed. Moreover, as the input button display T4, the first input button display T41 for approving the following of the traffic congestion and the maintenance of the own lane and the second input button display T42 for approving a lane change to the right to overtake the congestion section are displayed.

Similarly to the above example, the display of the input button display T4 is associated with the display of the autonomy level display T23. That is, the first input button display T41 for approving the maintenance of the first traveling lane, that is, the left lane, is disposed on the left side. The first input button display T41 is displayed in the same display mode as the autonomy level display T23 corresponding to the autonomous driving. On the other hand, the second input button display T42 for approving the lane change from the own lane to the second traveling lane on the right side of the own lane is disposed on the right side. The second input button display T42 is displayed in a display mode similar to that of the autonomy level display T23 corresponding to the hands-off driving to which the shift is made from the autonomous driving in accordance with the lane change.

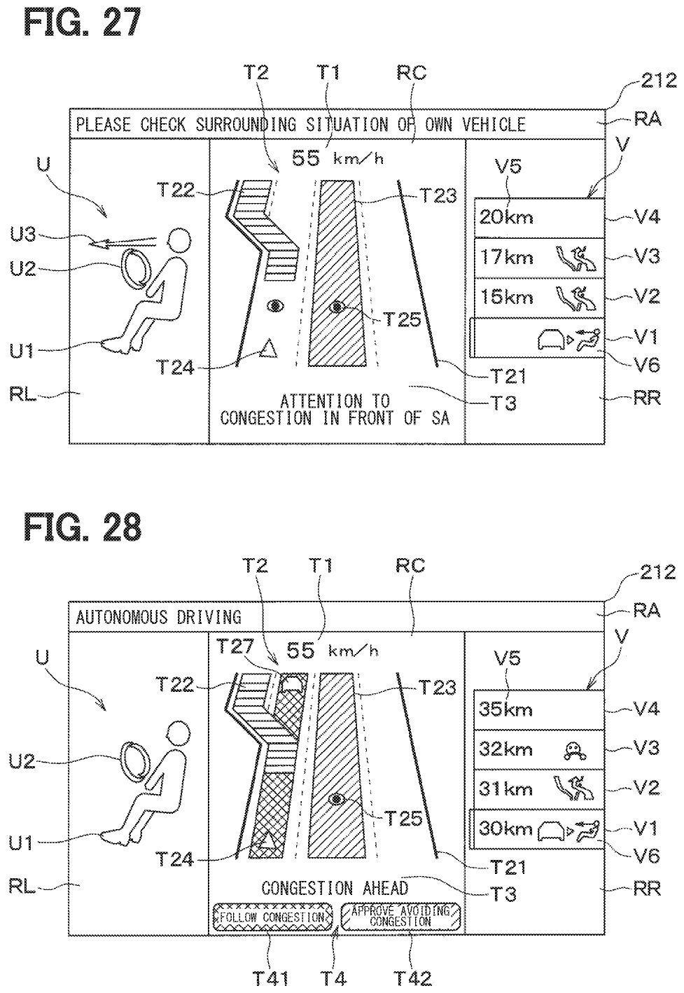

When the input operation is performed on the second input button display T42 for approving the lane change to the right on the display screen illustrated in FIG. 26, the display of the input button display T4 is deleted, and the display screen is switched over to the display state illustrated in FIG. 27. At this time point, the driving switch accompanying the shift from the autonomous driving to the hands-off driving is necessary. Therefore, information for calling attention to the monitoring obligation is displayed in the upper display area RA. The line-of-sight icon U3 is lit or displayed in a blinking manner. The monitoring obligation icon T25 is displayed at a position on the near side in the first traveling lane where the own vehicle icon T24 exists. Furthermore, the display of the event icon V6 indicating the driving switch from the autonomous driving to the hands-off driving at this time point in the first segment V1 is kept in the display state illustrated in FIG. 26.

At this time point, the own vehicle is scheduled to exit from the first traveling lane in which the own vehicle is currently traveling and to interrupt or terminate the autonomous driving associated with the exit. Thus, the autonomy level display T23 corresponding to the autonomous driving and the autonomous driving icon T27 near the end point of the autonomy level display T23, displayed on the first traveling lane on the display screen illustrated in FIG. 26, are hidden in FIG. 27. The display state illustrated in FIG. 26 is kept for the second traveling lane and the overtaking lane. The monitoring obligation icon T25 displayed at the position on the near side in the first traveling lane where the own vehicle icon T24 exists can also be deleted. In the character information display T3, the display of information for calling attention to the occurrence of traffic congestion in front of the service area is kept. Moreover, the input button display T4 is deleted.

### Additional Operation Example 3

FIG. 28 illustrates an information presentation example when the own vehicle is approaching the end of the traffic congestion under the following conditions. That is, the example of FIG. 28 is substantially the same as the example of FIG. 3.
The own vehicle is approaching a junction having a branch during autonomous driving.
In a scheduled traveling route, the own vehicle does not proceed to the branch road side at the junction and goes straight on the main lane road.
The own vehicle is traveling in the leftmost first traveling lane among the three lanes on one side of the main lane road.
Traffic congestion has occurred in a branch guidance lane and a branch road ahead of the branch guidance lane, and the end of the traffic congestion has reached the own lane. Traffic congestion in the own lane has been resolved near the start point of the parallel traveling section with the branch guidance lane.
No traffic congestion has occurred in the two lanes on the right side of the own lane, that is, on the median strip side.

In this case, as illustrated in FIG. 28, information indicating that the own vehicle is currently in autonomous driving is displayed in the upper display area RA. In the left display area RL, the driving condition display U is set to a display state corresponding to the autonomous driving.

The event concerning the junction that the own vehicle is approaching is not displayed in the time chart V of the right display area RR. On the other hand, in the time chart V, the following events (1) to (4) scheduled when the own vehicle leaves the expressway on which the own vehicle is currently traveling are displayed in the first segment V1 to the fourth segment V4, respectively.

(1) The autonomous driving is terminated before arrival at a point where a branch guidance lane toward an exit interchange is generated by a predetermined distance or a predetermined time, and the driving is shifted to the hands-off driving. The distance display V5 in the first segment V1 indicates when the driving switch from the autonomous driving to the hands-off driving, that is, the performance of the monitoring obligation, must be executed.

(2) A lane change is made from the first traveling lane to the branch guidance lane under the hands-off driving.

(3) When the own vehicle leaves the expressway at the exit interchange, the driving is shifted to the hands-on driving.

(4) The own vehicle arrives at the destination.

By accepting the temporary congestion traveling and keeping the first traveling lane where the own vehicle is currently traveling, it is possible for the driver to continue the use of the second task while avoiding the interruption or the termination of the currently executed autonomous driving. On the other hand, it is also possible to change lanes to the second traveling lane on the right side to avoid the congestion traveling. However, for changing lanes, it is necessary to interrupt the currently executed autonomous driving and second task.

Therefore, in the central display area RC, the autonomy level display T23 corresponding to the autonomous driving that can be continued by keeping the lane is displayed in the first traveling lane that is the own lane in which the own vehicle icon T24 exists. Such an autonomy level display T23 has an information presentation function similar to that of the graphic route display G12 (e.g., see FIG. 3) in the above embodiments. As in the case of FIG. 3, in the autonomy level display T23, a substantially central portion in the extending direction is superimposed on a portion in the vicinity of the end of the traffic congestion in the congestion display T22 extending from the branch guidance lane. Further, the autonomous driving icon T27 is displayed at the far-side end. On the other hand, in the second traveling lane that is the adjacent lane to which a lane change may be made, the autonomy level display T23 corresponding to the hands-off driving is displayed from the near side to the far side, and the monitoring obligation icon T25 is displayed on the near side. The autonomy level display T23 and the like are not displayed in the overtaking lane that is not the adjacent lane of the own lane.

In the character information display T3, information indicating that traffic congestion has occurred in a place to which the own vehicle is going is displayed. Moreover, as the input button display T4, the first input button display T41 indicating “FOLLOW CONGESTION” for selecting to follow the traffic congestion and keep the own lane and the second input button display T42 for approving the avoidance of the traffic congestion are displayed.

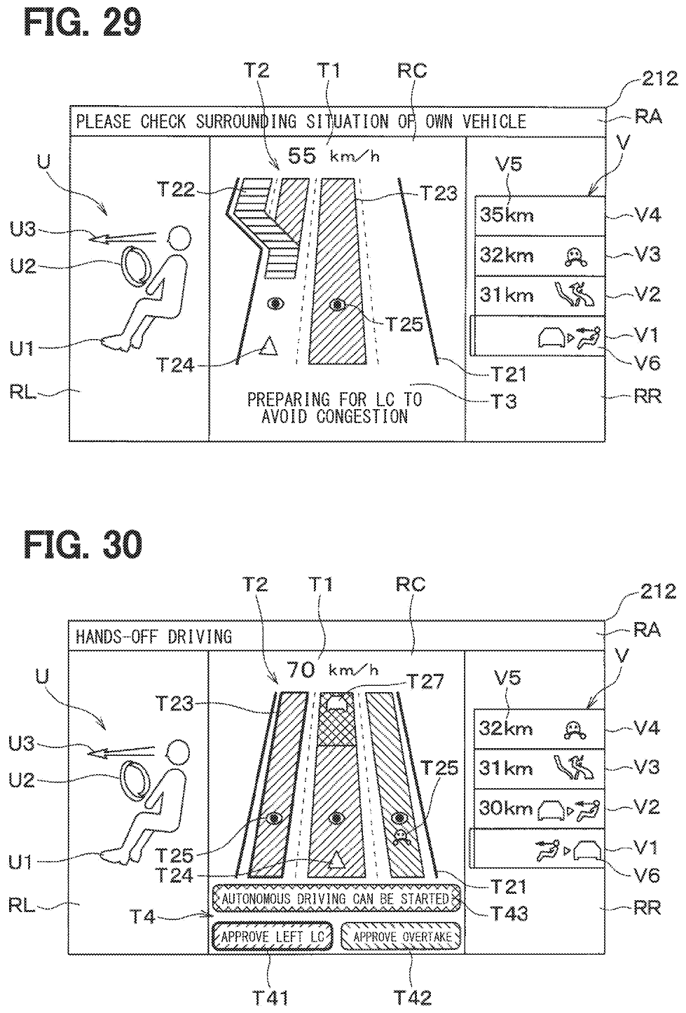

When the input operation is performed on the second input button display T42 for approving the avoidance of the traffic congestion on the display screen illustrated in FIG. 28, the display screen is switched over to the display state illustrated in FIG. 29. At this time point, it is necessary to shift from the autonomous driving to the hands-off driving and to switch the driving for the shift. Therefore, information for calling attention to the monitoring obligation is displayed in the upper display area RA. The line-of-sight icon U3 is lit or displayed in a blinking manner. Furthermore, the monitoring obligation icon T25 is displayed at a position on the near side in the first traveling lane where the own vehicle icon T24 exists.

The event icon V6 indicating the driving switch from the autonomous driving to the hands-off driving at this time point is displayed in the first segment V1 in the time chart V. That is, the display of the event icon V6 indicating the driving switch from the autonomous driving to the hands-off driving in the first segment V1 is kept from the display state illustrated in FIG. 28. However, the distance display V5 in the first segment V1 displayed adjacent to the event icon V6 is deleted.

At this time point, the own vehicle is scheduled to exit from a portion on the nearer side than the congestion section in the first traveling lane in which the own vehicle is currently traveling, and to interrupt or terminate the autonomous driving associated with the exit. Therefore, the autonomy level display T23 and the autonomous driving icon T27 corresponding to the autonomous driving, displayed on the first traveling lane on the display screen illustrated in FIG. 28, are hidden in FIG. 29. After the shift to the hands-off driving in accordance with the current lane change to the second traveling lane this time, a lane change for returning to the first traveling lane can be made again under the hands-off driving. That is, there is a possibility that the own vehicle changes lanes from the second traveling lane again in a section after the resolution of the traffic congestion in the first traveling lane. Thus, the autonomy level display T23 corresponding to the hands-off driving is displayed in such a section. The display state illustrated in FIG. 28 is kept for the second traveling lane and the overtaking lane.

In the character information display T3, the display of information for calling attention to that preparation for lane change for avoiding traffic congestion is in progress is kept. Moreover, the input button display T4 is deleted.

FIG. 30 illustrates an example of a display screen after the display screen illustrated in FIG. 29, that is, after a lapse of a predetermined time from the completion of the lane change to the second traveling lane. In this case, the upper display area RA and the driving condition display U are set to a display state corresponding to the hands-off driving.

At this time point, by keeping the second traveling lane that is the own lane, it is possible to shift from the hands-off driving to the autonomous driving, that is, restart the autonomous driving. Therefore, the event icon V6 indicating the shift from the hands-off driving to the autonomous driving is displayed in the first segment V1 in the time chart V. Since this transition can be executed at this time point, the distance display V5 is hidden in the first segment V1.

On the other hand, as described above, the lane change for returning to the first traveling lane can be made again under the currently executed hands-off driving. In order to overtake the preceding vehicle traveling ahead of the own vehicle, a lane change to the overtaking lane is also possible. However, in the case of changing lanes to the overtaking lane, the driving autonomy level may be temporarily lowered from the current level in consideration of the possibility of unexpected behavior of other vehicles around the own vehicle.

That is, in the case of keeping the second traveling lane which is the own lane, it is possible to continue the currently executed hands-off driving as it is or to shift to the autonomous driving. Further, it is possible to perform the lane change to the first traveling lane on the left side while continuing the currently executed hands-off driving. On the other hand, in the case of a lane change to the right overtaking lane, it is necessary to return to the second traveling lane as soon as possible. Hence it is possible to perform the lane change to the right overtaking lane by shifting to the hands-on driving. Further, it is not possible to continue traveling in the overtaking lane. Thus, during the traveling in the overtaking lane, the hands-off driving can be performed, but the autonomous driving is not performed.

Therefore, in the central display area RC, the autonomy level display T23 corresponding to the hands-off driving and the autonomy level display T23 corresponding to the autonomous driving are displayed in the second traveling lane that is the own lane where the own vehicle icon T24 exists. The autonomy level display T23 corresponding to the autonomous driving is displayed on the farther side, that is, the more proceeding-direction side, than the autonomy level display T23 corresponding to the hands-off driving. At a position on the near side in the second traveling lane, the monitoring obligation icon T25 is displayed so as to be superimposed on the autonomy level display T23 corresponding to the hands-off driving. Further, at a position on the far side in the second traveling lane, the autonomous driving icon T27 is displayed so as to be superimposed on the autonomy level display T23 corresponding to the autonomous driving.

In the first traveling lane to which the own lane is adjacent on the left side, the autonomy level display T23 corresponding to the hands-off driving is displayed from the near side to the far side. As in the case of FIG. 25, the autonomy level display T23 is displayed in a different display mode that is similar to but distinguishable from the autonomy level display T23 corresponding to the hands-off driving in the second traveling lane that is the own lane. The monitoring obligation icon T25 is displayed at a position on the near side in the first traveling lane.

In the overtaking lane to which the own lane is adjacent on the right side, the autonomy level display T23 corresponding to the hands-on driving is displayed from the near side to the far side. The monitoring obligation icon T25 and the hands-on icon T26 are each displayed at a position on the near side in the overtaking lane.

As the input button display T4, the first input button display T41 for approving a lane change to the left side, the second input button display T42 for approving a lane change to the overtaking lane, and the third input button display T43 for approving the start of the autonomous driving are displayed. In the third input button display T43, information indicating that autonomous driving can be started is displayed.

Even when the lane change to the first traveling lane on the left side of the own lane is performed, the autonomous driving can be started after the lane change. Therefore, in the graphic information display T2, the autonomous driving icon T27 and the autonomy level display T23 corresponding to the autonomous driving may be displayed at the position on the far side in the first traveling lane, similarly to the second traveling lane.

### Additional Operation Example 4

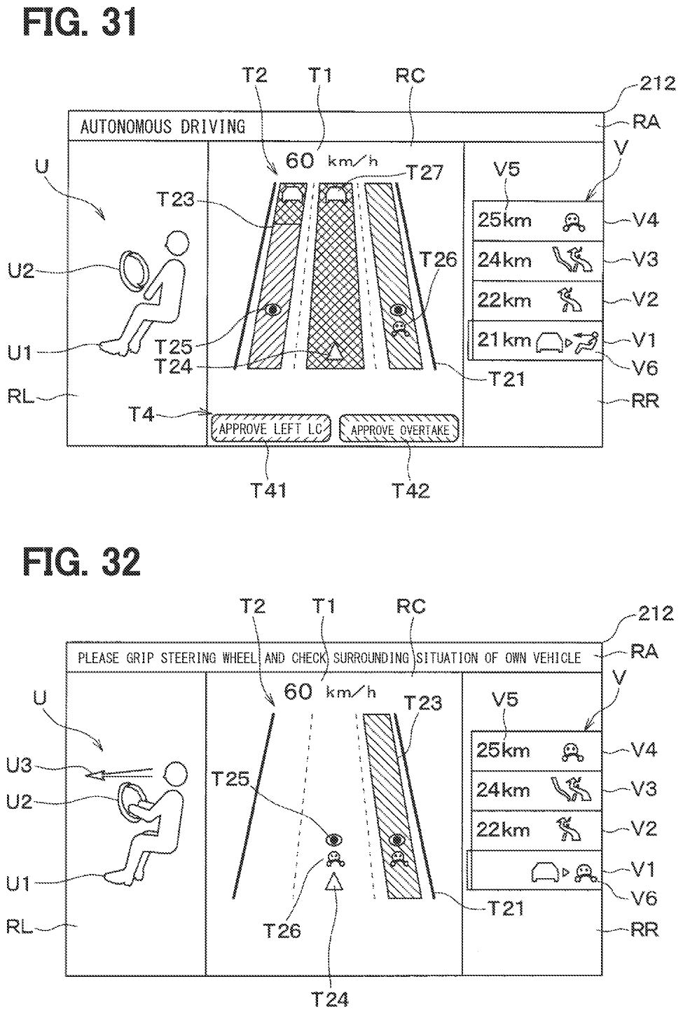

FIG. 31 illustrates an example of a display screen when the own vehicle is traveling in the second traveling lane by the autonomous driving and there is neither a branch nor traffic congestion within a short-distance range of a place to which the own vehicle is going. Specifically, FIG. 31 corresponds to a state after the start of the autonomous driving in response to the input operation of the third input button display T43 for approving the start of the autonomous driving on the display screen illustrated in FIG. 30.

In this case, the upper display area RA and the left display area RL are set to a display state corresponding to the autonomous driving. In the time chart V in the right display area RR, the following events (1) to (4) scheduled when the own vehicle leaves the expressway on which the own vehicle is currently traveling are displayed in the first segment V1 to the fourth segment V4, respectively.

(1) The autonomous driving is terminated before arrival at a point where a branch guidance lane toward an exit interchange is generated by a predetermined distance or a predetermined time, and the driving is shifted to the hands-off driving.

(2) A lane change is made to the first traveling lane under the hands-off driving.

(3) A lane change is made from the first traveling lane to the branch guidance lane under the hands-off driving.

(4) When the own vehicle leaves the expressway at the exit interchange, the driving is shifted to the hands-on driving.

At present, it is possible to continue the autonomous driving and the second task by keeping the second traveling lane that is the own lane. On the other hand, by interrupting or terminating the autonomous driving, it is possible to change lanes to the first traveling lane on the left side or the overtaking lane on the right side. When lanes are changed to the left side, it is necessary to shift from the autonomous driving to the hands-off driving and to switch the driving associated with the shift. After the lane change to the first traveling lane, the autonomous driving can be resumed. In contrast, at the time of changing lanes to the right side, it is necessary to shift from the autonomous driving to the hands-on driving and to switch the driving associated with the shift in consideration of returning to the second traveling lane as soon as possible after the lane change.

Therefore, in the central display area RC, the autonomy level display T23 corresponding to the autonomous driving is displayed from the near side to the far side in the second traveling lane that is the own lane where the own vehicle icon T24 exists. Such an autonomy level display T23 has an information presentation function similar to that of the graphic route display G12 (e.g., see FIG. 2) in the above embodiments. In the overtaking lane to which the own lane is adjacent on the right side, the autonomy level display T23 corresponding to the hands-on driving is displayed from the near side to the far side. Then autonomy level display T23 corresponding to the hands-off driving and the autonomy level display T23 corresponding to the autonomous driving are displayed in the first traveling lane to which the own lane is adjacent on the left side. In the first traveling lane, the autonomy level display T23 corresponding to the autonomous driving is displayed on the farther side, that is, the more proceeding-direction side, than the autonomy level display T23 corresponding to the hands-off driving.

An autonomous driving icon T27 is displayed at a position on the far side in the second traveling lane that is the own lane. The monitoring obligation icon T25 is displayed at a position on the near side in the first traveling lane to which the own lane is adjacent on the left side so as to overlap with the autonomy level display T23 corresponding to the hands-off driving. Further, at a position on the far side in the first traveling lane, the autonomous driving icon T27 is displayed so as to be superimposed on the autonomy level display T23 corresponding to the autonomous driving. The monitoring obligation icon T25 and the hands-on icon T26 are displayed at positions on the near side in the overtaking lane to which the own lane is adjacent on the right side. As the input button display T4, the first input button display T41 for approving a lane change to the first traveling lane on the left side and the second input button display T42 for approving a lane change to the overtaking lane on the right side are displayed. The display of the input button display T4 is associated with the display of the autonomy level display T23.

When the input operation is performed on the second input button display T42 for approving the overtaking on the display screen illustrated in FIG. 31, the display screen is switched over to the display state illustrated in FIG. 32. At this time point, it is necessary to shift from the autonomous driving to the hands-on driving and to switch the driving for the shift. Therefore, information for calling attention to the hands-on operation and the monitoring obligation is displayed in the upper display area RA. The driving condition display U in the left display area RL is set to a display state corresponding to the hands-on driving. That is, the driver icon U1 is displayed in the “hands-on state” in which the hands are placed on the steering icon U2. The line-of-sight icon U3 is lit or displayed in a blinking manner. Furthermore, the event icon V6 indicating the driving switch from the autonomous driving to the hands-on driving at this time point is displayed in the first segment V1 in the time chart V.

The monitoring obligation icon T25 and the hands-on icon T26 are displayed at positions on the near side in the second traveling lane where the own vehicle icon T24 exists. The autonomy level display T23 in the second traveling lane is deleted. The autonomy level display T23 and various icons are deleted for the first traveling lane that has not been selected as the lane change destination. For the overtaking lane selected as the lane change destination, the display state such as the autonomy level display T23 in FIG. 31 is kept.

When the lane change to the overtaking lane is completed, the display screen is switched over to the display state illustrated in FIG. 32. In FIG. 32, the upper display area RA and the driving condition display U are set to a display state corresponding to the hands-on driving. That is, information indicating that the hands-on driving is currently performed is displayed in the upper display area RA. The driving condition display U in the left display area RL is set to a display state corresponding to the hands-on driving. Specifically, the driver icon U1 is displayed in the “hands-on state”, and the line-of-sight icon U3 is set to a lighting state, that is, a display state.

As described above, the own vehicle traveling in the overtaking lane needs to return to the second traveling lane as soon as possible. Thus, the event icon V6 indicating the lane change to the second traveling lane is displayed in the first segment V1 in the time chart V. After the own vehicle returns to the second traveling lane, the hands-off driving can be performed.

Therefore, in the central display area RC, the autonomy level display T23 corresponding to the hands-on driving is displayed from the near side to the far side in the overtaking lane that is the own lane in which the own vehicle icon T24 exists. Further, the autonomy level display T23 corresponding to the hands-off driving is displayed on the second traveling lane that is the lane change destination from the near side to the far side. The autonomy level display T23 and the like are not displayed in the first traveling lane that is not the adjacent lane of the own lane.

The monitoring obligation icon T25 and a hands-on icon T26 are displayed at positions on the near side in the overtaking lane that is the own lane. The monitoring obligation icon T25 is displayed at a position on the near side in the second traveling lane that is the lane change destination. After returning to the second traveling lane and performing the hands-off driving for a predetermined time, the own vehicle can execute the autonomous driving. Therefore, on the display screen illustrated in FIG. 30, as in FIG. 30, the autonomous driving icon T27 and the autonomy level display T23 corresponding to autonomous driving may be displayed at positions on the far side in the second traveling lane.

### Brief Description of Additional Operation Examples

As described above in detail, in the above additional embodiments, the presentation control unit 245 presents information corresponding to the change destination lane to which lanes can be changed from the own lane that is the lane on which the own vehicle is traveling. That is, for example, the presentation control unit 245 presents information corresponding to the lane type of the change destination lane. Specifically, for example, the presentation control unit 245 presents information corresponding to whether the change destination lane is the traveling lane or the overtaking lane. When the change destination lane is the overtaking lane, the presentation control unit 245 presents information related to a subsequent lane change for returning to the own lane that is the lane before the change.

With such a configuration, by receiving the presentation of the information corresponding to the change destination lane, the occupant of the own vehicle such as the driver can promptly and accurately make an appropriate determination concerning the lane change. Therefore, it is possible to improve the confidence of the occupant of the own vehicle in the in-vehicle system 10.

In the additional embodiments described above, when the required monitoring obligation and/or hands-on operation is not performed within a predetermined wait time, a necessary protective measure is performed. Specifically, for example, a warning can be made concerning the performance of the monitoring obligation and/or the hands-on operation. Alternatively, for example, the lane change can be canceled.

When the national road traffic law allows, a decrease or temporary decrease in the driving autonomy level at the time of the lane change may be external. That is, even when the request and performance of the monitoring obligation and/or the hands-on operation are made for the lane change, the driving autonomy level actually executed by the driving control ECU 17 may be unchanged before and after the lane change. Specifically, for example, at the time of a lane change from the second traveling lane to the overtaking lane, even when a display corresponding to the hands-on driving is made on the screen, in practice, the vehicle control by the hands-off driving can be performed.

The above additional embodiments and additional operation examples can also be changed appropriately. Specifically, for example, the autonomy level display T23 and the like may be displayed in each of all the lanes except for the adjacent lane. Alternatively, for example, although the autonomy level display T23 and the like in the own lane are displayed or hidden in accordance with the lapse of time or the progress status of the lane change in each of the above examples, the present disclosure is not limited to such an aspect. That is, for example, the autonomy level display T23 and the like in the own lane may be always hidden. The character information display T3 and/or the input button display T4 may be displayed in a lower display area provided below the central display area RC or the like. The lower display area corresponds to the fifth display area D5 in FIG. 2 and the like.

Similar expressions such as “acquisition”, “calculation”, “estimation”, “detection”, “detection”, and “determination” can be appropriately replaced with each other within a range not technically contradictory. The “detection” or the “detection” and the “extraction” can be appropriately replaced within a range not technically contradictory.

It goes without saying that in the above embodiments, the elements constituting the embodiment are not necessarily essential unless otherwise specified as essential or considered to be obviously essential in principle. When numerical values such as the number, amount, and range of constituent elements are mentioned, the present disclosure is not limited to the specific numerical values unless otherwise specified as essential or obviously limited to the specific numerical values in principle. Similarly, when the shape, direction, positional relationship, and the like of a constituent element or the like are mentioned, the present disclosure is not limited to the shape, direction, positional relationship, and the like unless otherwise specified as essential or limited to a specific shape, direction, positional relationship, and the like in principle.

The modifications are not limited to the above-described examples. For example, multiple embodiments may be combined with each other under a condition that they are not technically inconsistent. Further, a plurality of modifications may be combined together. Furthermore, all or a part of the above-described embodiments and all or a part of the modifications may be combined with each other under a condition that they are not technically inconsistent.

(Brief)

The present disclosure described in the above embodiments and modifications includes the following viewpoints concerning the HMI control method and the HMI control program. The following aspects can be applied in combination with each other so long as they are not technically inconsistent.

According to an aspect present disclosure, an HMI control method is provided to control an HMI device mounted in a vehicle capable of autonomous steering control. The HMI control method includes instructions to be executed by an HMI control device to control the HMI device.

According to another aspect of the present disclosure, an HMI control program product is provided. The HMI control program product includes instructions to be executed by an HMI control device to control an HMI device mounted in a vehicle capable of autonomous driving.

In a first implementation, the instructions to be executed by the HMI control device includes:

acquiring an execution status of the autonomous steering control;

acquiring a traveling environment of the vehicle including congestion information;

acquiring an entry status of the vehicle into a congestion section included in the congestion information; and

presenting, by the HMI device, the congestion information corresponding to the congestion section and lane information related to a possibility of a lane change of the vehicle in a case where the execution status indicates that the autonomous steering control of the vehicle is being executed and the entry status indicates an entry of the vehicle into the congestion section.

In a second implementation, the instructions according to the first implementation may further include presenting lane-keeping information as the lane information when traffic congestion corresponding to the congestion section occurs in an own lane that is a lane on which the vehicle is traveling and it is recommended to keep traveling in the own lane also in the congestion section.

In a third implementation, the instructions according to the first implementation may further include presenting, as the lane information, lane change information in a case where (i) a traffic congestion occurs in the congestion section of a different lane which is different from an own lane on which the vehicle is traveling and (ii) a congestion traveling after a lane change from the own lane to the different lane in which the traffic congestion is occurred in the congestion section is recommended.

In a fourth implementation, the instructions according to any one of first to third implementations may further include: receiving an input operation made by an occupant of the vehicle including a driver; and performing an input request presentation prompting the occupant to make the input operation corresponding to the presented lane information.

In a fifth implementation, the instructions according to the fourth implementation may further include restricting a use of a second task available to the occupant in the HMI device during the autonomous steering control of the vehicle until the input operation is received.

In a sixth implementation, the instructions according to the first implementation may further include presenting lane change information as the lane information when traffic congestion corresponding to the congestion section occurs in an own lane that is a lane on which the vehicle is traveling and a lane change to another lane different from the own lane is possible.

In a seventh implementation, the instructions according to the sixth implementation may further include: receiving an input operation made by an occupant of the vehicle including a driver; and performing an input request presentation prompting the occupant to make the input operation corresponding to the presented lane information.

In an eighth implementation, the instructions according to the seventh implementation may further include restricting a use of a second task available to the occupant in the HMI device during the autonomous steering control of the vehicle until the input operation is received.

In a ninth implementation, the vehicle can perform, as the autonomous steering control, autonomous driving control in which the driver can use a second task in the HMI device on a condition that the vehicle is traveling in traffic congestion, and the instructions to be executed by the HMI control device further includes performing input request presentation for prompting the input operation to select whether to change lanes and approve non-execution of autonomous driving due to the condition being not satisfied or to keep the own lane and approve execution of autonomous driving and the use of the second task.

In a tenth implementation, the instructions to be executed by the HMI control device includes: acquiring an execution status of the autonomous steering control; acquiring a traveling environment of the vehicle including traffic information; and presenting, by the HMI device, the traffic information and lane information related to a possibility of a lane change in the vehicle when the execution status is that the autonomous steering control in the vehicle is being executed.

In an eleventh implementation, the instructions according to the tenth implementation may further include presenting information corresponding to a change destination lane to which a lane change from an own lane that is a lane on which the vehicle is traveling is possible.

In a twelfth implementation aspect, the instructions according to the eleventh implementation may further include presenting information related to a subsequent lane change for returning to the own lane that is the lane before the change when the change destination lane is an overtaking lane.

What is claimed is:

1. A human-machine interface (HMI) control device configured to control an HMI device mounted in a vehicle that is capable of performing an autonomous steering control, the HMI control device comprising:
a control status acquisition unit that acquires an execution status of the autonomous steering control;
a traveling environment acquisition unit that acquires a traveling environment of the vehicle including congestion information;
an entry status acquisition unit that acquires an entry status of the vehicle into a congestion section included in the congestion information; and
a presentation control unit that presents, by the HMI device, the congestion information corresponding to the congestion section and lane information related to a possibility of a lane change of the vehicle in a case where the execution status indicates that the autonomous steering control of the vehicle is being executed and the entry status indicates an entry of the vehicle into the congestion section,
wherein
the presentation control unit presents lane change information as the lane information in a case where (i) a traffic congestion occurs in the congestion section of a different lane which is different from an own lane on which the vehicle is traveling and (ii) a congestion traveling after a lane change from the own lane to the different lane in which the traffic congestion is occurred in the congestion section is recommended.

2. The HMI control device according to claim 1, further comprising
an operation reception unit that receives an input operation made by an occupant of the vehicle including a driver,
wherein the presentation control unit performs an input request presentation prompting the occupant to make the input operation corresponding to the presented lane information.

3. The HMI control device according to claim 2, wherein
the vehicle is capable of performing the autonomous steering control as a first task, and
the HMI control device further includes a task control unit that restricts a use of a second task available to the occupant in the HMI device during the autonomous steering control of the vehicle until the input operation is received.

4. The HMI control device according to claim 1, wherein
the presentation control unit presents information indicating a type of a change destination lane to which the lane change of the vehicle from the own lane is possible, and
the type of the change destination lane includes a travelling lane and an overtaking lane.

5. The HMI control device according to claim 4, wherein,
in a case where the type of the change destination lane is the overtaking lane, the presentation control unit further presents information related to a subsequent lane change for returning to the own lane on which the vehicle traveled before the lane change.

6. An HMI control device configured to control an HMI device mounted in a vehicle capable of autonomous steering control, the HMI control device comprising:
a control status acquisition unit that acquires an execution status of the autonomous steering control;
a traveling environment acquisition unit that acquires a traveling environment of the vehicle including traffic information; and
a presentation control unit that presents, by the HMI device, the traffic information and lane information, in a case where the execution status indicates that the autonomous steering control of the vehicle is being executed, the lane information indicating at least one of a driving autonomy level executable in a change destination lane to which the lane change is made or a driving condition of the change destination lane to which the lane change is made.

7. The HMI control device according to claim 6, wherein
the presentation control unit presents information indicating a type of the change destination lane, and the type of the change destination lane includes a travelling lane and an overtaking lane.

8. The HMI control device according to claim 7, wherein,
in a case where the type of the change destination lane is the overtaking lane, the presentation control unit further presents information related to a subsequent lane change for returning to the own lane on which the vehicle traveled before the lane change.

9. An HMI control program product stored in a computer-readable non-transitory storage medium, the HMI control program product comprising instructions to be executed by at least one processor of an HMI control device to control an HMI device, the HMI device being mounted in a vehicle capable of autonomous steering control, the instructions comprising:
acquiring an execution status of the autonomous steering control;
acquiring a traveling environment of the vehicle including congestion information;
acquiring an entry status of the vehicle into a congestion section included in the congestion information;
presenting, by the HMI device, the congestion information corresponding to the congestion section and lane information related to a possibility of a lane change of the vehicle in a case where the execution status indicates that the autonomous steering control of the vehicle is being executed and the entry status indicates an entry of the vehicle into the congestion section; and
presenting, as the lane information, lane change information in a case where (i) a traffic congestion occurs in the congestion section of a different lane which is different from an own lane on which the vehicle is traveling and (ii) a congestion traveling after a lane change from the own lane to the different lane in which the traffic congestion is occurred in the congestion section is recommended.

10. The HMI control program product according to claim 9, wherein
the instructions further include:
receiving an input operation made by an occupant of the vehicle including a driver; and
presenting an input request that prompts the occupant to make the input operation corresponding to the presented lane information.

11. The HMI control program product according to claim 10, wherein
the vehicle is capable of performing the autonomous steering control as a first task, and
the instructions further include restricting a use of a second task available to the occupant in the HMI device during the autonomous steering control of the vehicle until the input operation is received.

12. The HMI control program product according to claim 9, wherein
the instructions further include presenting information indicating a type of a change destination lane to which the lane change of the vehicle from the own lane is possible, and
the type of the change destination lane includes a travelling lane and an overtaking lane.

13. The HMI control program product according to claim 12, wherein
the instructions further include presenting information related to a subsequent lane change for returning to the own lane on which the vehicle traveled before the lane change in a case where the type of the change destination lane is the overtaking lane.
